(19) United States
(12) Patent Application Publication
(10) Pub. No.: US 2007/0009714 A1
(43) Pub. Date: Jan. 11, 2007

(54) Polymeric interlayers having a wedge profile

(76) Inventors: David J. Lee, Clarkston, MI (US); Hayati Yarkadas, Geneva (CH); Richard A. Hayes, Brentwood, TN (US); Luc A. Moeyersons, Mechelene (BE); Jimmy K. Travis, Fayetteville, NC (US); Randall A. Hollingsworth, Athens, OH (US); Michael L. Sanders, Landenberg, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/432,095

(22) Filed: May 11, 2006

Related U.S. Application Data
(60) Provisional application No. 60/679,815, filed on May 11, 2005.
(60) Provisional application No. 60/765,878, filed on Feb. 7, 2006.
(60) Provisional application No. 60/771,158, filed on Feb. 7, 2006.

(51) Int. Cl. B32B 3/00

(52) U.S. Cl. 428/172

(57) ABSTRACT

Continuous webs of self supporting adhesive sheet incorporating at least one layer of a polymeric composition such as polyvinyl butyral and comprising at least one area of a non-uniform thickness profile are provided. These webs are useful in the production of barrier windshields for heads-up display systems. The windshields may also optionally have acoustic barrier properties.

### CROSS-REFERENCE TO RELATED APPLICATIONS

This application claims priority under 35 U.S.C. §120 to U. S. Provisional Application No. 60/679815, filed on May 11, 2005; U.S. Provisional Application No. 60/765878, filed on Feb. 7, 2006; and U.S. Provisional Application No. 60/771158, filed on Feb. 7, 2006, each of which is incorporated herein by reference in its entirety.

### BACKGROUND OF THE INVENTION

1. Field of the Invention

The invention relates to the field of heads-up displays that have one or more of the beneficial properties of safety glass, and, more specifically, to heads-up displays that also have some sound barrier qualities.

2. Description of the Related Art

Several patents and publications are cited in this description in order to more fully describe the state of the art to which this invention pertains. The entire disclosure of each of these patents and publications is incorporated by reference herein.

Heads-up displays are becoming commonplace. Although the projection of information onto a transparent screen, such as a window, has many applications, heads-up displays are most commonly used to project vehicle operating information onto a vehicle windshield and thus into an operator's field of vision. This allows the vehicle operator to simultaneously view the displayed information while maintaining the observation of the area in front of the vehicle. Various heads-up display systems are currently within, for example, the automotive and aircraft industries.

A heads-up display system in an automobile minimizes the diversion of attention from observation of the road to periodically scanning the dashboard display. These systems allow the automobile operator to simultaneously focus their attention on the road in front of them while viewing essential vehicle operating information, thus providing enhanced safety for the vehicle passengers and others. The reflected images of the display may be focused at a position anywhere from immediately in front of the vehicle to optical infinity.

One type of heads-up display system reflects off a windshield with non-parallel glass surfaces, typically through the use of a wedge-shaped interlayer. The display reflects off the glass surfaces. Since typical windshields incorporate two panes of glass, two reflections are observed; typically the second reflection off the outside pane of glass appears as a secondary display image or as a ghost image. The displacement between the secondary display image and the primary display image reflected off the inside pane of glass garbles the display image, in some instances making the display unreadable. By providing non-parallel glass surfaces, the ghost image is greatly reduced if not eliminated. For examples of glass laminates having non-parallel glass surfaces owing to an interlayer with a wedge-shaped thickness profile, see U.S. Pat. Nos. 5,013,134; 5,087,502; 5,639,538; 5,812,332; and Intl. Patent Appln. Nos. WO 91/06031 and WO 02/103434.

Society continues to demand more functionality from laminated glass products beyond the safety and display characteristics described above. One area of need is for the automotive windshield to function as an acoustic barrier to reduce the level of noise intrusion into the automobile. See, for example, U.S. Pat. Nos. 5,190,826; 5,340,654; 5,368,917; 5,478,615; 5,464,659; 5,773,102; 6,074,732; 6,119,807; 6,132,882; 6,432,522; and Intl. Patent Appln. Nos. WO 01/19747 and WO 2004/039581.

Another area of societal need is the reduction of energy consumption within a structure, such as an automobile or building, to which the safety glass is applied. This need has been met through the development of solar control glass structures. The sun's energy may be divided into spectral regions, such as the ultraviolet region of light with wavelengths of 449 nm or less, the visible region of light with wavelengths of 450 nm to 749 nm, and the near infrared region of light with wavelengths of 750 nm to 2,100 nm. The solar energy intensity distribution across these spectral regions is 4.44% for the ultraviolet region, 46.3% for the visible region and 49.22% for the near infrared region. Removing the energy from the visible region would sacrifice visual transparency through windows and thereby vitiate one of the windows' key advantages. Since the near infrared region is not sensed by the human eye, however, typical solar control glass reduces the transmission of energy from the near infrared region. For example, the air conditioning load in the summer may be reduced in buildings, automobiles and the like equipped with solar control windows.

Conventional solar control glasses laminates may be obtained through modification of the glass or of the polymeric interlayer for laminated glass, or by the addition of further solar control layers.

One form of solar control laminated glass includes metallized substrate films, such as polyester films, which have electrically conductive metal layers, such as aluminum or silver metal, typically applied through a vacuum deposition or a sputtering process. The metallized films generally reflect light of the appropriate wavelengths to provide adequate solar control properties. For examples of this and related technologies, see U.S. Pat. Nos. 4,368,945; 4,450,201; 4,465,736; 4,782,216; 4,786,783; 4,973,511; 4,976,503; 5,071,206; 5,091,258; 5,932,329; 6,204,480; 6,391,400; 6,455,141; and European Patent Nos. 418 123 B1 and 1 342 565.

A more recent trend has been the use of nanoparticles of certain metal compounds that absorb rather than reflect infrared light. To preserve the clarity and transparency of the substrate, these materials ideally have nominal particle sizes below about 200 nanometers (nm). Because these materials do not form electrically conductive films, the operation of radiation transmitting and receiving equipment located inside structures protected by this type of solar control glazing is not impeded.

Two infrared absorbing metal oxides that have attained commercial significance are indium tin oxide and antimony tin oxide. Lanthanum hexaboride nanoparticles are also commercially available. Generally, the nanoparticles are introduced as a dispersion into the materials destined for the polymeric interlayers of glass laminates. The dispersion vehicle may be a plasticizer, a solvent, or another liquid. Alternatively, ultrafine metal oxide particles have been introduced directly into a polymer melt at the end concentration desired for the infrared absorbing interlayer. See, for example, U.S. Pat. Nos. 5,830,568; 6,315,848; 6,329,061; 6,579,608; 6,506,487; 6,620,477; 6,686,032; 6,632,274; 6,673,456; and 6,733,872; and Internatl. Appln. Publn. No. WO 02/060988.

Other metal-containing infrared absorptive materials have been used in solar control glass laminates. For example, U.S. Pat. No. 3,218,261 describes the dispersion of alkali metal ferricyanides in polyvinyl butyral sheets. U.S. Patent No. 3,298,898 describes solar absorbing safety glass laminates that include iron oxime chelates dissolved in polyvinyl butyral resin.

The present invention provides interlayer sheets which provide an enhanced combination of safety, display and acoustic attributes to laminates that may be used as reflection media for heads-up displays.

### SUMMARY OF THE INVENTION

Accordingly, the present invention provides interlayer sheets for use in a heads up display that have a non-uniform thickness profile. The interlayer sheets may be acoustic or non-acoustic. They may be laminates of more than one non-uniform sheet, or of a non-uniform sheet and one or more films or sheets which may be uniform or non-uniform in thickness. Non-acoustic sheets having a non-uniform thickness profile may be laminated to acoustic sheets having any thickness profile. In some preferred embodiments, the maximum thickness of the interlayer sheet is 15 mils (0.38 mm) or less. If the interlayer has no acoustic barrier properties, then the maximum thickness of the interlayer sheet is 15 mils (0.38 mm) or less. The interlayer sheets are suitable for further lamination, for example with one or more rigid sheets, and for use in heads-up displays.

### BRIEF DESCRIPTION OF THE DRAWINGS

FIG. 1 is a schematic sectional view of a full width self-supporting adhesive web showing its thickness profile;

FIG. 2 is a schematic partial sectional view of a transparent laminate showing the sheet thickness profile of one-half of the adhesive web of FIG. 1 which has been incorporated in the laminate;

FIG. 3 is a schematic sectional view of a full width self-supporting adhesive web showing its thickness profile, wherein the outer portions of the web are areas of uniform thickness, and the middle section of the web tapers to an area of minimum thickness;

FIG. 4 is a schematic sectional view of a full width self-supporting adhesive web showing its thickness profile, wherein the outer portions of the web are areas of uniform thickness, and the middle section of the web tapers to an area of minimum thickness, the area of minimum thickness has a rounded or smoothed thickness profile;

FIG. 5 is a schematic sectional view of a full width self-supporting adhesive web showing its thickness profile, wherein the outer portions of the web are tapered areas of decreasing thickness, and the middle section of the web tapers to an area of minimum thickness, the area of minimum thickness having a rounded or smoothed thickness profile;

FIG. 6 is a schematic sectional view of a full width self-supporting adhesive web showing its thickness profile, wherein the outer portions of the web are areas of uniform thickness have a rounded or smoothed thickness profile at the transition to the area of decreasing thickness profile in the middle section of the web, and the middle section of the web tapers to an area of minimum thickness having a rounded or smoothed thickness profile;

FIG. 7a is a schematic sectional view of a full width self-supporting adhesive web showing its thickness profile, wherein the outer portions of the web are areas of uniform thickness that taper to an area of uniform minimum thickness in the middle section of the web;

FIG. 7b is a schematic sectional view of a full width self-supporting adhesive web showing its thickness profile, wherein the outer portions of the web are areas of uniform minimum thickness that taper to an area of maximum thickness in middle section of the web; and

FIG. 8 is a schematic sectional view of a full width self-supporting adhesive web showing its thickness profile, wherein the outer portions of the web are areas of uniform thickness, the web increasing in thickness towards the middle of the web, then decreasing in thickness towards the middle section of the web, the middle section having a uniform thickness greater than the thickness of the outer areas of uniform thickness.

### DETAILED DESCRIPTION OF THE INVENTION

The following definitions apply to the terms as used throughout this specification, unless otherwise limited in specific instances.

The term “(meth)acrylic”, as used herein, alone or in combined form, such as “(meth)acrylate”, refers to acrylic and/or methacrylic, for example, acrylic acid and/or methacrylic acid, or alkyl acrylate and/or alkyl methacrylate.

The terms “finite amount” and “finite value”, as used herein, refer to an amount that is greater than zero.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, when used alone herein, is inclusive; more specifically, the phrase “A or B” means “A, B, or both A and B”. Exclusive “or” is designated herein by terms such as “either A or B” and “one of A or B”, for example.

All percentages, parts, ratios, and the like set forth herein are by weight, unless otherwise limited in specific instances.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

The present invention provides an interlayer for use in a heads-up display, said interlayer having a non-uniform thickness profile and said interlayer comprising one or more adjoining layers; wherein a first layer of the one or more adjoining layers has a non-uniform thickness profile; and wherein the first layer is optionally an acoustic layer, provided that when the first layer is not an acoustic layer, the maximum thickness of the interlayer is 15 mils (0.38 mm) or less.

In one embodiment, the invention is a continuous web of a self-supporting adhesive sheet incorporating at least one layer of an acoustic composition. The web is used as a transparent adhesive interlayer comprising a non-uniform thickness profile, or is useful for making a transparent adhesive interlayer comprising a non-uniform thickness profile.

Any acoustic composition is suitable for use in the present invention. Specific examples of suitable acoustic compositions include, for example; silicone/acrylate (“ISD”), resins as described in U.S. Pat. Nos. 5,190,826; 5,340,654; 5,624,763; 5,464,659 and 6,119,807; acoustic modified poly(vinyl chloride) as disclosed, for example, in U.S. Pat. Nos. 4,382,996 and 5,773,102 and commercially available from the Sekisui Company; acoustic modified poly(vinyl butyral) as disclosed, for example, within JP A05138840; and the like and combinations thereof. Recycled polymeric compositions may be used together with or in place of virgin polymeric compositions.

Preferably, the acoustic composition is an acoustic polyvinyl acetal composition. An example of a preferred acoustic polyvinyl acetal composition includes plasticized polyvinyl acetals produced by acetalizing polyvinyl alcohol with aldehydes containing 6 to 10 carbon atoms to a degree of acetalization of at least 50 percent. Preferred polyvinyl alcohols are those having an average polymerization degree of from about 1000 to about 3000 and are at least 95 mole percent in saponification degree. The aldehydes having 6 to 10 carbon atoms may include aliphatic, aromatic or alicyclic aldehydes. Specific examples of aldehydes having 6 to 10 carbon atoms include n-hexylaldehyde, 2-ethylbutyraldehyde, n-heptylaldehyde, n-octylaldehyde, n-nonylaldehyde, n-decylaldehyde, benzaldehyde, and cinnamaldehyde. The aldehydes may be used alone or in combinations of two or more. Preferably, the aldehydes have 6 to 8 carbon atoms.

The polyvinyl acetals may be produced by any suitable method. For example, the polyvinyl acetals may be prepared by dissolving the polyvinyl alcohol in hot water to obtain an aqueous solution, and adding the desired aldehyde and catalyst to the solution, which is maintained at the required temperature to cause the acetalization reaction to proceed. The crude reaction mixture is maintained at an elevated temperature to complete the reaction, followed by neutralization, washing with water and drying to obtain the desired product in the form of a resin powder. Preferably, the polyvinyl acetal produced has at least a 50 mole percent degree of acetalization.

The plasticizer to be admixed with the above produced polyvinyl acetal resin may be a monobasic acid ester, a polybasic acid ester or like organic plasticizer, or an organic phosphate or organic phosphite plasticizer. Preferred monobasic esters include glycol esters prepared by the reaction of triethylene glycol with butyric acid, isobutyric acid, caproic acid, 2-ethylbutyric acid, heptanoic acid, n-octylic acid, 2-ethylhexylic acid, pelagonic acid (n-nonylic acid), decylic acid, and the like and mixtures thereof. Other useful monobasic acid esters may be prepared by reaction of tetraethylene glycol or tripropylene glycol with the above mentioned organic acids. Preferred polybasic acid esters include those prepared from adipic acid, sebacic acid, azelaic acid, and the like and mixtures thereof, with a straight-chain or branched-chain alcohol having 4 to 8 carbon atoms. Preferred phosphate or phosphite plasticizers include tributoxyethyl phosphate, isodecylphenyl phosphate, triisopropyl phosphite and the like and mixtures thereof. More preferred plasticizers include monobasic esters such as triethylene glycol di-2-ethylbutyrate, triethylene glycol di-2-ethylhexoate, triethylene glycol dicaproate and triethylene glycol di-n-octoate, and dibasic acid esters such as dibutyl sebacate, dioctyl azelate and dibutylcarbitol adipate.

Preferably, the plasticizer is used in an amount of from about 20 to about 60 parts by weight per 100 parts by weight of the polyvinyl acetal resin. More preferably the plasticizer is used in an amount of from about 30 to about 55 parts by weight per 100 parts by weight of the polyvinyl acetal resin.

Further additives may be incorporated into the plasticized polyvinyl acetal composition, as described below. For example, metal salts of carboxylic acids, including potassium, sodium, or the like alkali metal salts of octylic acid, hexylic acid, butyric acid, acetic acid, formic acid and the like, calcium, magnesium or the like alkaline earth metal salts of the above mentioned acids, zinc and cobalt salts of the above mentioned acids, and stabilizers, such as surfactants such as sodium laurylsulfate and alkylbenzenesulfonic acids may be included.

Another preferred acoustic polyvinyl acetal composition includes plasticizer polyvinyl acetal resins which incorporate 4 to 6 carbon atoms in the acetal group and the mole ratio of the average amount of the ethylene groups bonded to acetyl groups is 8 to 30 mole percent of the total amount of the main chain ethylene groups. These polyvinyl acetal compositions may be prepared from polyvinyl alcohol resins which preferably have an average degree of polymerization of from about 500 to about 3000, more preferably from about 1000 to about 2500. The polyvinyl alcohol resins additionally have an average residual acetyl group level of from about 8 to 30 mole percent and preferably from about 10 to 24 mole percent. The aldehyde to be used to produce the polyvinyl acetal resins incorporate from 4 to 6 carbon atoms. Specific examples of aldehydes which incorporate from 4 to 6 carbon atoms include, for example, n-butyl aldehyde, isobutyl aldehyde, valer aldehyde, n-hexyl aldehyde and 2-ethylbutyl aldehyde and mixtures thereof. Preferred aldehydes include n-butyl aldehyde, isobutyl aldehyde and n-hexyl aldehyde and mixtures thereof. More preferably, the aldehyde is n-butyl aldehyde.

Preferably, the degree of acetalization for the polyvinyl acetal resin is 40 mole percent or greater, more preferably 50 mole percent or greater. These polyvinyl acetal compositions may be prepared as described above or below.

Useful plasticizers for these polyvinyl acetal compositions are as described above or below. Preferably the plasticizer is used in an amount of from about 30 to about 70 parts by weight, more preferably from about 35 to about 65 parts by weight per 100 parts by weight of the polyvinyl acetal resin. Further additives may be incorporated into the acoustic plasticized polyvinyl acetal composition as described above or below.

An example of a more preferred acoustic polyvinyl acetal composition is a polyvinyl butyral resin having a hydroxyl number in the range of from about 15 or 17 to about 23 with a single plasticizer in the amount in the range of from about 40 to about 50 parts per hundred. The poly(vinyl butyral) will typically have a weight average molecular weight range of from about 30,000 to about 600,000; preferably of from about 45,000 to about 300,000; more preferably from about 200,000 to 300,000 Daltons, as measured by size exclusion chromatography using low angle laser light scattering.

The preferred poly(vinyl butyral) material comprises, on a weight basis, about 15 or 17 to about 23 percent, preferably about 18 to about 21 percent, more preferably about 18 to about 19.5 percent and most preferably about 18 to about 19 percent hydroxyl groups calculated as polyvinyl alcohol (PVOH). In addition, the preferred poly(vinyl butyral) material will incorporate about 0 to about 10 percent, preferably about 0 to about 3 percent residual ester groups, calculated as polyvinyl ester, typically acetate groups, with the balance being butyraldehyde acetal. The poly(vinyl butyral) may incorporate a minor amount of acetal groups other than butyral, for example, 2-ethyl hexanal, as disclosed within U.S. Pat. No. 5,137,954.

Poly(vinyl butyral) resins may be produced by any suitable method. Aqueous and solvent acetalization methods are known in the art, for example.

The preferred poly(vinyl butyral) material contains plasticizer. Some examples of suitable plasticizers are described in U.S. Pat. No. 3,841,890, U.S. Pat. No. 4,144,217, U.S. Pat. No. 4,276,351, U.S. Pat. No. 4,335,036, U.S. Pat. No. 4,902,464, U.S. Pat. No. 5,013,779, and WO 96/28504. Plasticizers commonly employed are esters of a polybasic acid or a polyhydric alcohol. Particularly suitable plasticizers are triethylene glycol di-(2-ethyl butyrate), triethylene glycol di-2-ethylhexanoate, triethylene glycol di-n-heptanoate, oligoethylene glycol di-2-ethylhexanoate, tetraethylene glycol di-n-heptanoate, dihexyl adipate, dioctyl adipate, mixtures of heptyl and nonyl adipates, dibutyl sebacate, tributoxyethylphosphate, isodecylphenylphosphate, triisopropylphosphite, polymeric plasticizers such as the oil-modified sebacid alkyds, and mixtures of phosphates and adipates, and adipates and alkyl benzyl phthalates. Preferable plasticizers include diesters of polyethylene glycol such as triethylene glycol di(2-ethylhexanoate), tetraethylene glycol diheptanoate and triethylene glycol di(2-ethylbutyrate) and dihexyl adipate. Preferably, a single plasticizer is used within the plasticized polyvinyl butyral compositions. More preferably, the plasticizer is tetraethylene glycol diheptanoate.

The amount of plasticizer depends on the specific poly(vinyl butyral) resin and the properties desired in the application. Between about 40 to about 50 parts, preferably about 41 to about 49 parts, more preferably about 42 to about 49 parts, and still-more preferably about 44 to about 47 parts of plasticizer per hundred parts of resin are used. Preferably, the plasticizer is one that is compatible (that is, forms a single phase) in the amounts described hereinabove with a polyvinyl butyral having a hydroxyl number (OH number) of from about 15 or 17 to about 23.

An adhesion control additive, for, for example, controlling the adhesive bond between the glass rigid layer and the polymeric sheet, may also be utilized. These are generally alkali metal or alkaline earth metal salts of organic and inorganic acids. Preferably, they are alkali metal or alkaline earth metal salts of organic carboxylic acids having from 2 to 16 carbon atoms. More preferably, they are magnesium or potassium salts of organic carboxylic acids having from 2 to 16 carbon atoms. Specific examples of said adhesion control additives include, for example, potassium acetate, potassium formate, potassium propanoate, potassium butanoate, potassium pentanoate, potassium hexanoate, potassium 2-ethylbutylate, potassium heptanoate, potassium octanoate, potassium 2-ethylhexanoate, magnesium acetate, magnesium formate, magnesium propanoate, magnesium butanoate, magnesium pentanoate, magnesium hexanoate, magnesium 2-ethylbutylate, magnesium heptanoate, magnesium octanoate, magnesium 2-ethylhexanoate and the like and mixtures thereof. The adhesion control additive is typically used in the range of about 0.001 to about 0.5 weight percent based on the total weight of the acoustic composition. Other additives, such as antioxidants, ultraviolet absorbers, ultraviolet stabilizers, thermal stabilizers, colorants and the like, such as described above and within U.S. Pat. No. 5,190,826, may also be added to the polyvinyl butyral composition.

If higher levels of adhesion are desired within the laminates of the present invention, silane coupling agents may be incorporated into the acoustic compositions. Specific examples of the useful silane coupling agents include; gamma-chloropropylmethoxysilane, vinyltrichlorosilane, vinyltriethoxysilane, vinyltris(beta-ethoxyethoxy)silane, gamma-methacryloxypropyltrimethoxysilane, beta-(3,4-epoxycyclohexyl) ethyltrimethoxysilane, gammaglycidoxypropyltrimethoxysilane, vinyl-triacetoxysilane, gamma-mercaptopropyltrimethoxysilane, gamma-aminopropyltriethoxysilane, N-beta-(aminoethyl)-gamma-aminopropyl-trimethoxysilane, and the like and combinations thereof. Typically, said silane coupling agents are added at a level of about 0 to about 5 weight percent based on the total weight of the composition.

The acoustic compositions may incorporate an effective amount of a thermal stabilizer. Essentially any thermal stabilizer is suitable for use in the present invention. Preferred classes of thermal stabilizers include, without limitation, phenolic antioxidants, alkylated monophenols, alkylthiomethylphenols, hydroquinones, alkylated hydroquinones, tocopherols, hydroxylated thiodiphenyl ethers, alkylidenebisphenols, O—, N— and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like, and mixtures thereof. This should not be considered limiting. Essentially any thermal stabilizer is suitable for use in the present invention. The acoustic compositions preferably incorporate from about 0 to about 10.0 weight percent, more preferably from about 0 to about 5.0 weight percent, and still more preferably, from about 0 to about 1.0 weight percent thermal stabilizers, based on the total weight of the acoustic composition.

The acoustic compositions may incorporate an effective amount of UV absorbers. UV absorbers are well disclosed within the art. Any UV absorber is suitable for use in the present invention. Preferred general classes of UV absorbers include benzotriazoles, hydroxybenzophenones, hydroxyphenyl triazines, esters of substituted and unsubstituted benzoic acids, and the like and mixtures thereof. This should not be considered limiting. The acoustic compositions preferably incorporate from about 0 to about 10.0 weight percent, more preferably from about 0 to about 5.0 weight percent, and still more preferably, from about 0 to about 1.0 weight percent UV absorbers, based on the total weight of the acoustic composition.

The acoustic compositions may incorporate an effective amount of hindered amine light stabilizers, (HALS). Generally, hindered amine light stabilizers are secondary, tertiary, acetylated, N-hydrocarbyloxy substituted, hydroxy substituted N-hydrocarbyloxy substituted, or other substituted cyclic amines which further incorporate steric hindrance, generally derived from aliphatic substitution on the carbon atoms adjacent to the amine function. This should not be considered limiting. Essentially any hindered amine light stabilizer is useful in the present invention. The acoustic composition invention preferably incorporate from about 0 to about 10.0 weight percent, more preferably from about 0 to about 5.0 weight percent, and still more preferably from about 0 to about 1.0 weight percent hindered amine light stabilizers, based on the total weight of the acoustic composition.

The acoustic compositions may include other additives. Such additives may include plasticizers, processing aides, flow enhancing additives, lubricants, pigments, dyes or colorants, flame retardants, impact modifiers, nucleating agents to increase crystallinity, antiblocking agents such as silica, UV stabilizers, dispersants, surfactants, chelating agents, coupling agents, and the like. Suitable levels of these additives and methods of incorporating the additives into polymer compositions will be available to those of skill in the art. See, for example, “Modern Plastics Encyclopedia”, McGraw-Hill, New York, N.Y. 1995.

The continuous web of a self-supporting adhesive sheet incorporating at least one layer of an acoustic composition may be produced by any sheeting process known. The sheet of the present invention is preferably formed by extrusion. Extrusion is particularly preferred for formation of “endless” products, such as films and sheets, which emerge as a continuous length. In extrusion, the polymeric material, whether provided as a molten polymer or as plastic pellets or granules, is fluidized and homogenized. Preferably, the melt processing temperature of the polymeric compositions of the present invention is from about 50 C to about 300 C. More preferably, the melt processing temperature of the polymeric compositions of the present invention is from about 100 C to about 250 C. The polymeric compositions of the present invention have excellent thermal stability, which allows for processing at high enough temperatures to reduce the effective melt viscosity. This mixture is then forced through a suitably shaped die to produce the desired cross-sectional sheet shape. The extruding force may be exerted by a piston or ram (ram extrusion), or by a rotating screw (screw extrusion), which operates within a cylinder in which the material is heated and plasticized and from which it is then extruded through the die in a continuous flow. Single screw, twin screw, and multi-screw extruders may be used as known in the art. Different kinds of die are used to produce different products, such as sheets and strips (slot dies) and hollow and solid sections (circular dies). In this manner, sheets of different widths and thickness may be produced. After extrusion, the polymeric sheet is taken up on rollers or as flat sheets, cooled and taken off by means of suitable devices which are designed to prevent any subsequent deformation of the sheet.

Using extruders as known in the art, a sheet can be produced by extruding a layer of polymer over chilled rolls and then further drawing down the sheet to the desired size by tension rolls.

The multilayer interlayers of the present invention may be produced through any known method. For example, the multilayer web sheets may be produced through coextrusion whereby two or more slit dies are utilized, as described above. Alternatively, preformed films or sheets may be plied together to form the multilayer sheet structure. Any one or more of the layers of the multilayer sheet may have a non-uniform thickness profile, as described below. Conversely, any one or more of the layers of the multilayer sheet may have a uniform web sheet thickness profile, provided that the final multilayer sheet maintains the web sheet thickness profiles of the present invention. For example, it is contemplated that a thin film of the above mentioned silicone/acrylate “ISD” resins with a uniform thickness of from about 2 to about 5 mils may be plied onto a conventional polyvinyl butyral sheet with the web sheet thickness profiles of the present invention to produce an acoustic web sheet of the present invention.

For manufacturing large quantities of sheets, a sheeting calender is employed. The rough film is fed into the gap of the calender, a machine comprising a number of heatable parallel cylindrical rollers which rotate in opposite directions and spread out the polymer and stretch it to the required thickness. The last roller smooths the sheet thus produced. If the sheet is required to have a textured surface, the final roller is provided with an appropriate embossing pattern. Alternatively, the sheet may be reheated and then passed through an embossing calender. The calender is followed by one or more cooling drums. Finally, the finished sheet is reeled up or cut into lengths and stacked.

The sheets of the present invention may have smooth surfaces. Preferably, however, sheets to be used as interlayers within laminates have at least one roughened surface to effectively allow most of the air to be removed from between the surfaces of the laminate during the lamination process. Rough surfaces on one or both sides of the extruded sheet may be provided by the design of the die opening and the temperature of the die exit surfaces through which the extrudate passes. Roughening may also be accomplished by post-extrusion operations such as mechanically embossing the sheet after extrusion, or by melt fracture during extrusion of the sheet, and the like.

Many film and sheet formation methods, and extrusion processes in particular, can also be combined with a variety of post-extruding operations for expanded versatility. Such post-forming operations include altering round to oval shapes, blowing the film to different dimensions, machining, punching, stretching or orienting, rolling, calendering, coating, embossing, printing, radiation such as E-beam treatment to increase the Vicat softening point, and the like. The post extruding operations, together with the polymeric composition, the method of forming the polymer, and the method of forming the film or sheet, affect many properties, such as clarity, shrinkage, tensile strength, elongation at break, impact strength, dielectric strength and constant, tensile modulus, chemical resistance, melting point, heat deflection temperature, adhesion, and the like.

For example, films and sheets formed by any method may be oriented, uniaxially or biaxially, by stretching in one or both of the machine and transverse directions after formation according to any suitable methods. A biaxially oriented film may also be tensilized, that is, drawn further in the machine direction. Preferably, the drawing or stretching is conducted at a temperature of at least 10° C. above the glass transition temperature of the film material and more preferably also below the Vicat softening temperature of the film material, still more preferably at least 10° C. below the Vicat softening point.

Preferably, the shrinkage of the oriented films and sheets is controlled by heat stabilization, that is, by holding the film or sheet in a stretched position and heating for a few seconds before quenching. This stabilizes the oriented film or sheet, which then may shrink only at temperatures above the heat stabilization temperature. Preferably, the oriented films or sheets shrink less than 2 percent in both directions after 30 minutes at 150° C.

Preferably, one or both surfaces of the polymeric film or sheet is treated to enhance adhesion. This treatment may take any suitable form, including, without limitation, adhesives, primers including silanes, flame treatments, plasma treatments, electron beam treatments, oxidation treatments, corona discharge treatments, chemical treatments, chromic acid treatments, hot air treatments, ozone treatments, ultraviolet light treatments, sand blast treatments, solvent treatments, and the like, and combinations thereof. Adhesives and primers are preferred treatments for sheets.

Essentially any adhesive is suitable for use in the present invention. Specific examples of preferred adhesives include, without limitation, gamma-aminopropyl-triethoxysilane, N-beta-(aminoethyl)-gamma-aminopropyl-trimethoxysilane, and the like and mixtures thereof. Preferred adhesives that are commercially available include, for example, Silquest™ A-1100 silane, available from GE Silicones—OSi Specialties of Wilton, Conn., and believed to be gamma-aminopropyltrimethoxysilane, and Z-6020™ silane, available from the Dow Corning Corporation of Midland, Mich. The adhesives may be applied through melt processes or through coating processes, such as solution coating, emulsion coating, dispersion coating, and the like.

Likewise, essentially any primer is suitable for use in the present invention. Specific examples of preferred primers include polyallylamine-based primers, for example. One polyallylamine-based primer and its application to a poly(ethylene terephthalate) polymeric films are described in U.S. Pat. Nos. 5,411,845; 5,770,312; 5,690,994; and 5,698,329, for example. More preferably, both surfaces of the films and sheets of the invention are coated with a primer.

When using an adhesive or primer, one of ordinary skill in the art will be able to identify appropriate coating thicknesses and process parameters based on the composition of the polymer film or sheet, and of the adhesive or primer, and on the coating process.

The sheet properties may be further adjusted by adding certain additives and fillers to the polymeric composition, such as colorants, dyes, plasticizers, lubricants antiblock agents, slip agents, and the like, as recited above.

The sheets of the present invention may be further modified to provide valuable attributes to the sheets and to the laminates produced therefrom. For example, the sheets of the present invention may be treated by radiation, for example E-beam treatment of the sheets. E-beam treatment of the sheets of the present invention with an intensity in the range of about 2 MRd to about 20 MRd will provide an increase in the softening point of the sheet (Vicat Softening Point) of about 20 C to about 50 C. Preferably, the radiation intensity is from about 2.5 MRd to about 15 MRd.

A more preferred acoustic plasticized polyvinyl butyral sheet may be produced as described below. One of ordinary skill will be able to generalize the process to produce other preferred acoustic plasticized polyvinyl acetal sheets of the present invention.

Plasticized poly(vinyl butyral) sheet may be formed by initially mixing poly(vinyl butyral) resin with plasticizer, (and optionally other additives, such as described above for the coating matrix material), and then extruding the formulation through a sheet-shaping die, i.e. forcing molten, plasticized poly(vinyl butyral) through a horizontally long, vertically narrow die opening substantially conforming in length and width to that of the sheet being formed. The die may be adjusted to provide the desired sheet profiles of the present invention. Such sheeting processes are described in, for example, U.S. Pat. No. 2,829,399. The sheet may be dimensionally stabilized, for example, through processes as described in U.S. Pat. No. 3,068,525. Rough surfaces on one or both sides of the extruding sheet are provided by the design of the die opening and the temperature of the die exit surfaces through which the extrudate passes, as disclosed in, for example, U.S. Pat. No. 4,281,980. Alternative techniques for producing a rough surface on an extruding poly(vinyl butyral) sheet involve the specification and control of one or more of polymer molecular weight distribution, water content and melt temperature. Such techniques are disclosed in U.S. Pat. No. 2,904,844, U.S. Pat. No. 2,909,810, U.S. Pat. No. 3,679,788, U.S. Pat. No. 3,994,654, U.S. Pat. No. 4,161,565, U.S. Pat. No. 4,230,771, U.S. Pat. No. 4,292,372, U.S. Pat. No. 4,297,262, U.S. Pat. No. 4,575,540, U.S. Pat. No. 5,151,234 and EPO 0185,863. Alternatively, the as extruded sheet may be passed over a specially prepared surface of a die roll positioned in close proximity to the exit of the die which imparts the desired surface characteristics to one side of the molten polymer. Thus, when the surface of such roll has minute peaks and valleys, sheet formed of polymer cast thereon will have a rough surface on the side which contacts the roll which generally conforms respectively to the valleys and peaks of the roll surface. Such die rolls are disclosed in, for example, U.S. Pat. No. 4,035,549. As is known, this rough surface is only temporary and particularly functions to facilitate deairing during laminating after which it is melted smooth from the elevated temperature and pressure associated with autoclaving and other lamination processes.

The present invention is concerned with various web sheet thickness profiles. The profiles may belong to layers produced from acoustic or non-acoustic polymeric compositions. The suitable materials for non-acoustic compositions with non-uniform thickness profiles are the materials described below as suitable for additional layers.

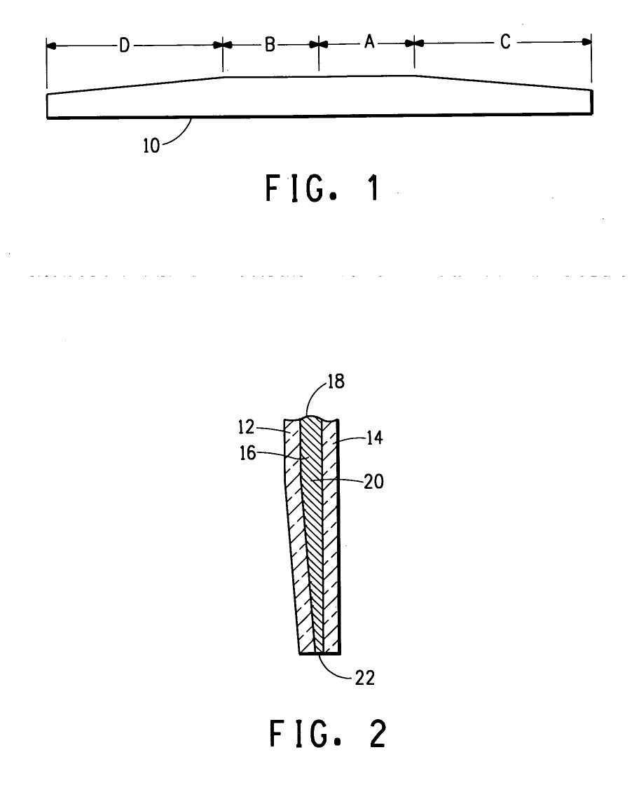

Referring now to the drawings, there is shown in FIG. 1, a self-supporting adhesive web 10 having a uniform thickness profile across at least 20% of its width as shown by areas A and B and a wedge-shaped thickness profile in areas C and D. As shown in FIG. 2, a laminate comprises sheets of glass 12 and 14 having sandwiched therebetween adhesive interlayer 16. Interlayer 16 has a uniform thickness profile extending from edge 18 to point 20 and a wedge-shaped thickness profile from point 20 to edge 22.

Referring to FIG. 2, the image area will lie in the region of the laminate between point 20 and edge 22. The geometry of interlayer 16 from point 20 to edge 22 is defined as wedge-shaped, that is the distance between the inner surfaces of glass sheets 12 and 14 decreases when measured at various points from point 20 to edge 22. This wedge shape is expressed in terms of the wedge angle created by intersecting planes parallel to the first and second surfaces of interlayer 16.

To provide the properties required for the expected performance of conventional polyvinyl butyral sheeting, the acoustic polyvinyl acetal sheet of the present invention may be thicker than conventional polyvinyl butyral sheeting. The thickness of the sheet of the present invention may be in the range of from about 15 mils to about 70 mils, preferably from about 20 mils to about 60 mils, and more preferably from about 30 mils to about 45 mils at the thickest point of the sheet profile of the present invention. The desired thickness of the acoustic sheet may represent the use of one sheet or may represent multiple sheets having individual thicknesses such that when they are stacked together they provide the desired total thickness of the interlayer. The acoustic sheets of the present invention may be of any width and length.

Alternatively, for economic and environmental reasons, it may be desirable to conserve materials by using a sheet with a maximum thickness of 20 mils or less, or 15 mils (0.38 mm) or less. Again, the thin sheet may be the acoustic or non-acoustic sheet, it may be a sheet of a uniform or non-uniform thickness profile, and it may be a sheet of any width and length. The maximum thickness of 20 mils or less is preferred for acoustic sheets, and the maximum thickness of 15 mils or less is preferred for non-acoustic sheets.

These web sheet profiles may take many forms. Within the present invention, “non-uniform thickness profiles” are areas where the web sheet is changing, that is, variable and not constant. Web sheet thickness profiles as described herein refer to the thickness of a cross-section of the web sheet along a line that is perpendicular to the extrusion direction.

One web sheet profile of the present invention comprises a non-uniform thickness profile. The non-uniform thickness profile may by defined by a linear angle, by multiple linear angles, or by a curve or in a non-linear manner. The sheets may be tapered on one side or may be tapered on both. The non-uniform thickness profile has been generally referred to as a wedge shape within the art. For the sake of brevity, this terminology will be utilized herein, with the understanding that the wedge shape may be defined independently as a linear angle, by multiple linear angles, or by a curve or in a non-linear manner. The wedge shaped interlayer of the present invention will generally include distances between the first interlayer sheet surface and the second interlayer sheet surface which decrease when measured at various points from the top of the interlayer sheet to its bottom. The wedge-shaped characteristic of the interlayer sheet may be expressed in terms of the wedge angle, which is created by intersecting planes parallel to the first and second surfaces of the interlayer sheet.

The interlayer wedge angle is selected pursuant to the anticipated installation angle of the display, thickness of the transparent sheet material, and angle of incidence of the projected image so as to substantially superimpose the reflected images from the inner surface and from the other internal and external surfaces of the display into a substantially singular image in the eyes of the observer.

Linear wedge angles may be greater than zero to about 0.06 degrees (1.05 milliradian) or greater. Preferably, linear wedge angles are from about 0.005 (0.09 milliradian) to about 0.04 (0.70 milliradian) degrees. More preferably, linear wedge angles are from about 0.006 (0.11 milliradian) to about 0.03 degrees (0.52 milliradian). This should not be considered limiting. Essentially any wedge angle may find utility within the present invention. The wedge angle will be a complex function of, for example, the installation angle of the windshield, the thickness of the glass sheets, and the angle of incidence of the projected image, such that the reflected images from the two glass surfaces are substantially superimposed to provide a singular viewed image. The wedge angle needs to be correctly selected based on the exact heads up display system desired. Such web sheets which incorporate non-uniform thickness profiles are disclosed within, for example, U.S. Pat. No. 5,013,134, U.S. Pat. No. 5,087,502, and WO 91/06031.

Further preferred web sheet profiles of the present invention comprise at least one area of uniform thickness profile and at least one area of a non-uniform thickness profile. A vertex is formed at each juncture where an area of uniform thickness meets an area of non-uniform thickness, or where two different areas of non-uniform thickness meet. These vertices may be curved such that a sharp edge is not detectable by physical inspection of the curved vertex.

The non-uniform thickness profile is generally referred to as a “wedge shape”. This terminology is used herein, although the wedge shape may be defined independently as a linear angle, by multiple linear angles, or by a curve or in a non-linear manner. This type of web sheet profile has been referred to within the art as “partial wedging”. The sheets may be tapered on one side or it may be tapered on both sides.

Preferably, the area of uniform thickness profile starts at one of the outer edges of the web and the area of non-uniform thickness profile starts at the other outer edge of the web. In other words, this web sheet thickness profile generally includes a flat area starting at one outer edge of the web sheet and expanding across the web sheet until meeting the non-uniform thickness profile, which as before, may be referred to as the wedge shaped section, at which point the web sheet tapers down in thickness according to the parameters as laid out above.

Preferably, the uniform thickness profile spans at least 20 percent of the width of the web to allow for tint bands with minimal color variation and improved laminate optics. More preferably, said uniform thickness profile spans at least 25 percent of the width of the web to allow for tint bands with minimal color variation and improved laminate optics. Most preferably, said uniform thickness profile spans at least 33 percent of the width of the web to allow for tint bands with minimal color variation and improved laminate optics.

The wedged area should have a width sufficient to accommodate the image area, but otherwise the size of the area is not critical provided that the area along uniform thickness profile side of the sheet is as described above. Such web sheets which incorporate at least one area of uniform thickness profile and at least one area of non-uniform thickness profile are disclosed within, for example, U.S. Pat. No. 5,812,332.

Other preferred embodiments of the present invention comprise at least one area of uniform thickness profile and at least two areas of a non-uniform thickness profile; at least two areas of uniform thickness profile and at least one area of a non-uniform thickness profile; and so forth. These other preferred-embodiments may also have a vertex or two or more vertices, as described above. The areas of non-uniform or non-uniform thickness may be identical, symmetrical, or different and not symmetrical, depending on specific manufacturing and or end use requirements.

For example, the areas of uniform thickness profile may extend from each edge of the web and the area of non-uniform thickness profile decreases in thickness from the areas of uniform thickness to the center of the web, such that by splitting the web in the region of non-uniform thickness (typically near the midpoint of the web), two pieces of sheet are obtained each having at least one area of uniform thickness and at least one area of non-uniform thickness. As a further example, the area of uniform thickness profile starts at the center of the web and continuing in both directions toward the outer edges of the web and the two areas of non-uniform thickness profile increasing in thickness from the outer edges of the web to the area of uniform thickness at the center of the web, such that by splitting the web in the region of uniform thickness, two pieces of sheet are obtained each having at least one area of uniform thickness and at least one area of non-uniform thickness.

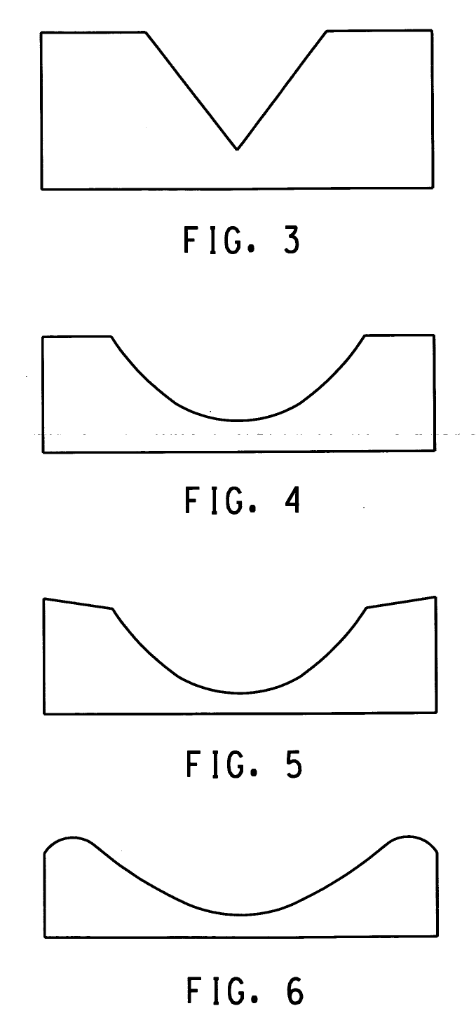

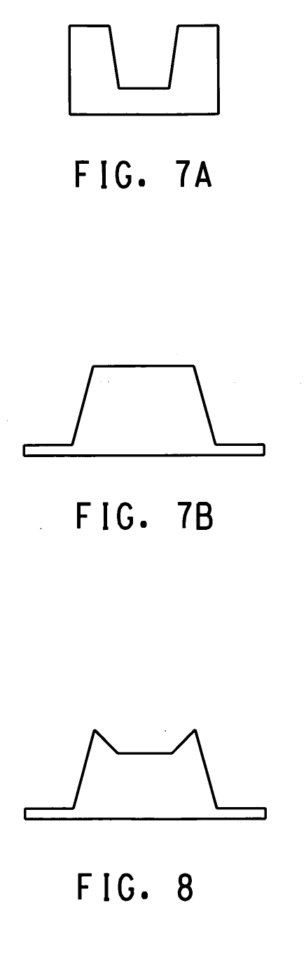

These and other preferred thickness profiles for interlayers of the invention are depicted in FIGS. 3 through 8. These figures are schematic only and not to scale. As noted elsewhere, the interlayers of the invention may be laminates of two or more sheets or films, one or more of which may have a uniform thickness profile.

As described above, the web sheets of the present invention may incorporate one or more additional layers. Both films and sheets are suitable as additional layers. Any polymer known may be used within said additional layers. Specific examples of preferable additional layer materials include; the acoustic resins as described above, acrylic resins, acrylate resins, methacrylic resins, methyl acrylate resins, ethyl acrylate resins, isobutyl acrylate resins, butyl acrylate resins, methyl methacrylate resins, ethyl methacrylate resins, isobutyl methacrylate resins, butyl methacrylate resins, ethyl methacrylate-ethyl acrylate copolymer resins, methyl methacrylate-styrene copolymer resins, methyl methacrylate-ethyl acrylate copolymer resins, urethane modified acrylic resins, polyester modified acrylic resins, polystyrene resins, polyolefin resins, polyethylene resins, polypropylene resins, urethane resins, urea resins, epoxy resins, polyester resins, alkyd resins, polyamide resins, polyamideimide resins, polyvinyl resins, phenoxy resins, nylon resins, amino resins, melamine resins, chlorine-containing resins, chlorinated polyether resins, fluorine-containing resins, polyvinyl acetals, polyvinyl formals, poly(vinyl butyrate)s, polyacetylene resins, poly ether resins, silicone resins, ABS resins, polysulfone resins, polyamine sulfone resins, polyether sulfone resins, polyphenylene sulfone resins, vinyl chloride resins, vinylidene chloride resins, vinyl acetate resins, polyvinyl alcohol resins, polyvinyl carbazole resins, butyral resins, polyphenylene oxide resins, polypyrrole resins, polyparaphenylene resins, ultraviolet-curing resins, cellulose derivatives, nitrocelluloses, cellulose esters, cellulose acetate butyrates, cellulose acetate propionates, cellulose acetates, diethylene glycol bis-allyl carbonate poly-4-methylpentene, polytetrafluoroethylene, polytrifluoroethylene, polyvinylidene fluoride, polyvinylidene chloride, high density polyethylene, low density polyethylene, linear low density polyethylene, ultralow density polyethylene, polyolefins, polyvinyl acetates, poly(ethylene-co-vinyl acetate) resins, poly(ethylene-co-glycidylmethacrylate), poly(ethylene-co-methyl (meth)acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-(meth)acrylic acid), metal salts of poly(ethylene-co-(meth)acrylic acid), poly((meth)acrylates), such as poly(methyl methacrylate), poly(ethyl methacrylate), and the like, poly(ethylene-co-carbon monoxide), poly(vinyl acetate), poly(ethylene-co-vinyl acetate), poly(vinyl alcohol), poly(vinyl butyral), poly(ethylene-co-vinyl alcohol), polypropylene, polybutylene, poly(cyclic olefins), polyesters, poly(ethylene terephthalate), poly(1,3-propyl terephthalate), poly(1,4-butylene terephthalate), PETG, poly(ethylene-co-1,4-cyclohexanedimethanol terephthalate), poly(vinyl chloride), PVDC, poly(vinylidene chloride), polystyrene, syndiotactic polystyrene, poly(4-hydroxystyrene), novalacs, poly(cresols), polyamides, nylons, nylon 6, nylon 46, nylon 66, nylon 612, polycarbonates, poly(bisphenol A carbonate), polysulfides, poly(phenylene sulfide), polyethers, poly(2,6-dimethylphenylene oxide), polysulfones, starch, starch derivatives, modified starch, thermoplastic starch, cationic starch, anionic starch, starch esters, such as starch acetate, starch hydroxyethyl ether, alkyl starches, dextrins, amine starches, phosphate starches, dialdehyde starches, cellulose, cellulose derivatives, modified cellulose, cellulose esters, such as cellulose acetate, cellulose diacetate, cellulose priopionate, cellulose butyrate, cellulose valerate, cellulose triacetate, cellulose tripropionate, cellulose tributyrate, and cellulose mixed esters, such as cellulose acetate propionate and cellulose acetate butyrate, cellulose ethers, such as methylhydroxyethylcellulose, hydroxymethylethylcellulose, carboxymethylcellulose, methyl cellulose, ethylcellulose, hydroxyethycellulose, and hydroxyethylpropylcellulose, polysaccharides, alginic acid, alginates, phycocolloids, agar, gum arabic, guar gum, acaia gum, carrageenan gum, furcellaran gum, ghatti gum, psyllium gum, quince gum, tamarind gum, locust bean gum, gum karaya, xantahn gum, gum tragacanth, proteins, Zein®, (a prolamine derived from corn), collagen, (extracted from animal connective tissue and bones), and derivatives thereof such as gelatin and glue, casein, (the principle protein in cow milk), sunflower protein, egg protein, soybean protein, vegetable gelatins, gluten, thermoplastic starch (U.S. Pat. No. 5,362,777) and the like and copolymers thereof and mixtures thereof. Recycled materials may also be used, together with or in place of virgin materials. This should not be considered limiting. Essentially any polymer may find utility in an additional layer in the present invention.

Poly(vinyl butyral) is a preferred additional layer material. The poly(vinyl butyral) will typically have a weight average molecular weight range as described above with respect to acoustic materials. The preferable poly(vinyl butyral) material for additional layers comprises, on a weight basis, about 5 to about 30 percent, preferably about 11 to about 25 percent, and more preferably about 15 to about 22 percent hydroxyl groups calculated as polyvinyl alcohol (PVOH). In addition, the residual ester groups and acetal groups other than butyral are also as described above.

The preferred poly(vinyl butyral) layers contain plasticizer in an amount that depends on the specific poly(vinyl butyral) resin and the properties desired in the application. Suitable plasticizers are as described above for acoustic compositions comprising poly(vinyl butyral). Generally between about 15 to about 80 parts of plasticizer per hundred parts of resin, preferably about 25 to about 45 parts of plasticizer per hundred parts of resin are used in the additional layer. This latter concentration is generally used with poly(vinyl butyral) resins containing 17 to 25 percent vinyl alcohol by weight.

The additional layers comprising poly(vinyl butyral)may also contain additives other than plasticizers, as described above and in the amounts described above for acoustic compositions.

Poly(ethylene-co-vinyl acetate) resin compositions are also preferred materials for additional layers. Poly(ethylene-co-vinyl acetate) resins suitable for optical polymeric sheets of the present invention may be obtained from the Bridgestone Corporation, the Exxon Corporation, Specialized Technologies Resources, Inc. and DuPont. Suitable poly(ethylene-co-vinyl acetate) resins preferably have a vinyl acetate level between about 10 to about 50 weight percent, more preferably between about 20 to about 40 weight percent, and still more preferably between about 25 to about 35 weight percent based on the total weight of the copolymer. The poly(ethylene-co-vinyl acetate) resins may incorporate other unsaturated comonomers. Preferably, the other unsaturated comonomers are selected from the group consisting of methyl(meth)acrylate, butyl(meth)acrylate, glycidyl methacrylate, (meth)acrylic acid and mixtures thereof. Preferably, the ethylene copolymers of the present invention incorporate between about 0 and about 50 weight percent of the other unsaturated comonomer, more preferably between about 0 and about 25 weight percent, and still more preferably about 0 weight percent of the other unsaturated comonomer, based on the total weight of the copolymer.

The additional layer comprising poly(ethylene-co-vinyl acetate) resin may incorporate additives, including plasticizers. The additives are as described above. The amounts may be different, however. For example, the plasticizer level within the poly(ethylene-co-vinyl acetate) resin composition generally does not exceed about 5 weight percent based on the total weight of the copolymer. See,e.g., the “Modern Plastics Encyclopedia.”

The poly(ethylene-co-vinyl acetate) resin composition preferably incorporates an organic peroxide. Preferably, the organic peroxide has a thermal decomposition temperature of about 70 C or greater in a half-life of 10 hours. Preferably, the organic peroxide has a thermal decomposition temperature of about 100 C or greater. The selection of the appropriate organic peroxide may be performed by one skilled in the art with consideration of sheet-forming temperature, process for preparing the composition, curing (bonding) temperature, heat resistance of body to be bonded, storage stability, and the like. Specific examples of the preferred organic peroxide include, for example, 2,5-dimethylhexane-2,5-dihydroperoxide, 2,5-dimethyl-2,5-(t-butylperoxy)hexane-3-di-t-butylperoxide, t-butylcumyl peroxide, 2,5-dimethyl-2,5-di(t-butylperoxy)hexane, dicumyl peroxide, alpha, alpha′-bis(t-butylperoxyisopropyl)benzene, n-butyl-4,4-bis(t-butylperoxy)valerate, 2,2-bis(t-butylperoxy)butane, 1,1-bis(t-butylperoxy)cyclohexane, 1,1-bis(t-butylperoxy)-3,3,5-trimethylcyclohexane, t-butylperoxybenzoate, benzoyl peroxide, t-butylperoxyacetate, methyl ethyl ketone peroxide, 2,5-dimethyl-2,5-bis(t-butylperoxy)-3,3,5-trimethylcyclohexane, 1-bis(t-butylperoxy)cyclohexane, 2,5-dimethylhexyl-2,5-bisperoxybenzoate, t-butyl hydroperoxide, p-menthane hydroperoxide, p-chlorobenzoyl peroxide, hydroxyheptyl peroxide, chlorohexanone peroxide, octanoyl peroxide, decanoyl peroxide, lauroyl peroxide, cumyl peroxyoctoate, succinic acid peroxide, acetyl peroxide, t-butylperoxy(2-ethylhexanoate), m-toluoyl peroxide, t-butylperoxyisobutylate and 2,4-dichlorobenzoyl peroxide and the like and mixtures thereof. Preferably, the organic peroxide level is within the range of from about 0.1 weight percent to about 5 weight percent, based on the total weight of the poly(ethylene-co-vinyl acetate) resin composition.

Alternatively, the poly(ethylene-co-vinyl acetate) resin may be cured by light. In this instance, the organic peroxide may be replaced with a photoinitiator or photosensitizer. Preferably, the level of said photoinitiator is within the range of from about 0.1 weight percent to about 5 weight percent, based on the total weight of the poly(ethylene-co-vinyl acetate) resin composition. Specific examples of the preferred photoinitiator include, for example, benzoin, benzophenone, benzoyl methyl ether, benzoin ethyl ether, benzoin isopropyl ether, benzoin isobutyl ether, dibenzyl, 5-nitroacenaphtene, hexachlorocyclopentadiene, p-nitrodiphenyl, p-nitroaniline, 2,4,6-trinitroaniline, 1,2-benzanthraquinone, 3-methyl-1,3-diaza-1,9-benzanthrone and the like and mixtures thereof.

The poly(ethylene-co-vinyl acetate) resin composition may incorporate materials which contain acryloyl(oxy) group containing compounds, methacryloyl(oxy) group containing compounds and/or epoxy group containing compounds for improvement or adjustment of various properties of the resin, such as, for example, mechanical strength, adhesion properties, optical characteristics such as transparency, heat resistance, light-resistance, rate of crosslinking and the like. These materials are preferably used at a level of about 50 weight percent or less, based on the total weight of the poly(ethylene-co-vinyl acetate) resin composition. These materials are more preferably used at a level of about 10 weight percent or less, based on the total weight of the poly(ethylene-co-vinyl acetate) resin composition. These materials are most preferably used at a level within the range of from about 0.1 weight percent to about 2 weight percent, based on the total weight of the poly(ethylene-co-vinyl acetate) resin composition. Examples of the acryloyl(oxy) and methacryloyl(oxy) group containing compounds include generally derivatives of acrylic acid or methacrylic acid, such as esters and amides of acrylic acid or methacrylic acid. Examples of the ester residue include linear alkyl groups (e.g., methyl, ethyl, dodecyl, stearyl and lauryl), a cyclohexyl group, a tetrahydrofurfuryl group, an aminoethyl group, a 2-hydroxyethyl group, a 3-hydroxypropyl group, 3-chloro-2-hydroxypropyl group. Further, the esters include esters of acrylic acid or methacrylic acid with polyhydric alcohol such as ethylene glycol, triethylene glycol, polypropylene glycol, polyethylene glycol, trimethylol propane or pentaerythritol. An example of the amide includes diacetone acrylamide. Examples of polyfunctional compounds include esters of plural acrylic acids or methacrylic acids with polyhydric alcohol such as glycerol, trimethylol propane or pentaerythritol. Examples of the epoxy group containing compounds include triglycidyl tris(2-hydroxyethyl)isocyanurate, neopentylglycol diglycidyl ether, 1,6-hexanediol diglycidyl ether, allyl glycidyl ether, 2-ethyihexyl glycidyl ether, phenyl glycidyl ether, phenol(ethyleneoxy)sub-5 glycidyl ether, p-tert-butylphenyl glycidyl ether, diglycidyl adipate, diglycidyl phthalate, glycidyl methacrylate and butyl glycidyl ether, and the like and mixtures thereof.

The poly(ethylene-co-vinyl acetate) resin compositions may also incorporate a silane coupling agent, as described above, to enhance the adhesive strengths. These silane coupling agent materials are preferably used at a level of about 5 weight percent or less, based on the total weight of the poly(ethylene-co-vinyl acetate) resin composition. These silane coupling agent materials are more preferably used at a level within the range of from about 0.001 weight percent to about 5 weight percent, based on the total weight of the poly(ethylene-co-vinyl acetate) resin composition.

Ethylene copolymers which incorporate acid functionality are also a more preferred additional layer material. Also, suitable ethylene acid copolymers comprise from about 0.1 weight percent to about 30 weight percent of one or more acid comonomers, preferably from about 10 weight percent to about 25 weight percent of the acid comonomer(s), and more preferably from about 15 weight percent to about 25 weight percent of the acid comonomer(s), based on the total weight of the polymer. Those of skill in the art are aware that the level of acid comonomer(s) in an ethylene acid copolymer affects the copolymer's adhesion to glass.

Preferred acid comonomer(s) include, without limitation, (meth)acrylic acid, itaconic acid, maleic acid, maleic anhydride, fumaric acid, and monomethyl maleic acid. More preferably, the acid comonomer is (meth)acrylic acid.

The acid groups of the ethylene acid copolymers are preferably at least partially neutralized with one or more metal cations. The metal cations may be monovalent, divalent, trivalent, or of even higher valence. Preferred monovalent ions include ions of sodium, potassium, lithium, silver, mercury, and copper. Preferred divalent ions include ions of beryllium, magnesium, calcium, strontium, barium, copper, cadmium, mercury, tin, lead, iron, cobalt, nickel, and zinc. Preferred trivalent ions include ions of aluminum, scandium, iron, and yttrium. Preferred ions of even higher valence include ions of titanium, zirconium, hafnium, vanadium, tantalum, tungsten, chromium, cerium, and iron. Preferably, when the metal cation is tetravalent or of higher valence, complexing agents, such as stearate, oleate, salicylate, and phenolate groups are included, as described in U.S. Pat. No. 3,404,134. Ions of sodium, lithium, magnesium, zinc, aluminum, and combinations of two or more of sodium, lithium, magnesium, zinc, and aluminum are more preferred. Sodium ions, zinc ions, and mixtures of sodium and zinc ions are still more preferred. Generally, sodium ions are associated with high optical clarity, and zinc ions are associated with high moisture resistance. Preferably, from about 0 to about 100 percent, more preferably from about 10 to about 100 percent, and still more preferably from about 20 to about 80 percent of the acid groups in the ethylene acid copolymers are neutralized.

The ethylene acid copolymers may optionally contain other comonomers. Preferred comonomers include alkyl(meth)acrylates, wherein the alkyl group is a branched or unbranched moiety including up to about 20 carbons. The alkyl groups may be unsubstituted, or substituted with one or more hydroxyl groups. Preferred alkyl groups include methyl, ethyl, propyl, isopropyl, butyl, isobutyl, tert-butyl acrylate, tert-butyl, octyl, undecyl, octadecyl, dodecyl, 2-ethylhexyl, isobornyl, lauryl, 2-hydroxyethyl acrylate, 2-hydroxyethyl. Other preferred comonomers include, without limitation, glycidyl(meth)acrylate, poly(ethylene glycol) (meth)acrylate, poly(ethylene glycol) methyl ether (meth)acrylate, poly(ethylene glycol) behenyl ether (meth)acrylate, poly(ethylene glycol) 4-nonylphenyl ether (meth)acrylate, poly(ethylene glycol) phenyl ether (meth)acrylate, dialkyl maleate (C1 to C4 alkyl), dialkyl fumarate (C1 to C4 alkyl), dimenthyl fumarate, vinyl acetate, vinyl propionate, and the like, and mixtures thereof. More preferred comonomers include, without limitation, methyl(meth)acrylate, butyl(meth)acrylate, glycidyl(meth)acrylate, vinyl acetate, and mixtures of two or more of methyl(meth)acrylate, butyl(meth)acrylate, glycidyl(meth)acrylate, and vinyl acetate.

The other comonomer(s) may be present in a finite amount up to about 50 weight percent, more preferably up to about 25 weight percent, and still more preferably up to about 10 weight percent, based on the total weight of the ethylene acid copolymer.

Ethylene acid copolymers suitable for use in the present invention may be polymerized and neutralized as described, for example, in U.S. Pat. Nos. 3,404,134; 5,028,674; 6,500,888; and 6,518,365.

The ethylene copolymer compositions of the present invention may further incorporate additives which effectively reduce the melt flow of the resin, to the limit of producing thermoset films and sheets. The use of such additives will enhance the upper enduse temperature of the film, sheet, and laminates of the present invention. Typically, the enduse temperature will be enhanced up to 20 to 70° C. In addition, laminates produced from such materials will be fire resistant. By reducing the melt flow of the ethylene copolymer interlayer of the present invention, said material will have a reduced tendency to melt and flow out of the laminate and, in turn, serve as additional fuel for a fire.

Specific examples of melt flow reducing additives include organic peroxides, such as 2,5-dimethylhexane-2,5-dihydroperoxide, 2,5-dimethyl-2,5-di(tert-betylperoxy)hexane-3, di-tert-butyl peroxide, tert-butylcumyl peroxide, 2,5-dimethyl-2,5-di(tert-butylperoxy)hexane, dicumyl peroxide, alpha, alpha′-bis(tert-butyl-peroxyisopropyl)benzene, n-butyl-4,4-bis(tert-butylperoxy)valerate, 2,2-bis(tert-butylperoxy)butane, 1,1-bis(tert-butyl-peroxy)cyclohexane, 1,1-bis(tert-butylperoxy)-3,3,5-trimethyl-cyclohexane, tert-butyl peroxybenzoate, benzoyl peroxide, and the like and mixtures combinations thereof.

Preferably the organic peroxide decomposes at a temperature of about 100° C. or higher to generate radicals. More preferably, the organic peroxides have a decomposition temperature which affords a half life of 10 hours at about 70° C. or higher to provide improved stability for blending operations. Typically, the organic peroxides will be added at a level of between about 0.01 to about 10 weight percent based on the total weight of the ethylene copolymer composition. If desired, initiators, such as dibutyltin dilaurate, may be used. Typically, initiators are added at a level of from about 0.01 weight percent to about 0.05 weight percent based on the total weight of the ethylene copolymer composition. If desired, inhibitors, such as hydroquinone, hydroquinone monomethyl ether, p-benzoquinone, and methylhydroquinone, may be added for the purpose of enhancing control to the reaction and stability. Typically, said inhibitors would be added at a level of less than about 5 weight percent based on the total weight of the ethylene copolymer composition.

As described above, the copolyethylene resins may incorporate additives, such as thermal stabilizers, UV absorbers, UV stabilizers, plasticizers, organic peroxides, adhesion promoters and the like and mixtures thereof. See, e.g., the “Modern Plastics Encyclopedia.”

Preferred rigid sheets for use as additional layers include glass, for example. The term “glass” as used herein includes window glass, plate glass, silicate glass, sheet glass, float glass, colored glass, specialty glass which may, for example, include ingredients to control solar heating, glass coated with sputtered metals such as silver, for example, glass coated with ATO and/or ITO, E-glass, Solex™ glass (available from PPG Industries of Pittsburgh, Pa.), Toroglass™, and the like. A typical glass type is 90 mil thick annealed flat glass, and it is preferable to orient the tin side of the glass to the interlayer to achieve optimal adhesion. Alternatively, the rigid sheet may be a rigid polymeric sheet, such as, for example, polycarbonate, acrylics, polyacrylate, cyclic polyolefins, such as ethylene norbornene polymers, metallocene-catalyzed polystyrene, and the like, and mixtures or combinations thereof. Preferably, the rigid sheet is transparent. A metal or ceramic plate may be used as a rigid sheet, however, if transparency or clarity is not required in the solar control laminate.

Preferably, the additional layer imparts additional attributes, such as solar control properties or additional acoustical barrier properties. For example, additional layers may be coextruded onto one or both outer surfaces of the acoustic web sheets of the invention to reduce the tendency of the sheets to block or stick together within the roll during storage or shipment. Such use of additional layers is described within, for example, U.S. Pat. No. 5,190,826 and U.S. Pat. No. 5,340,654. Alternatively, preformed additional layers, such as a Butacite® sheet, (a product of the DuPont Company), with a uniform thickness of 15 mils, may be plied onto one or both outer surfaces of the acoustic web sheets of the present invention to reduce the tendency of the sheets to block or stick together within the roll during storage or shipment.

The additional layer(s) may also have functional coatings applied to them, such as infrared absorbers and infrared reflectors. In applications in which electrical conductivity may not be disadvantageous, the infrared reflectors may be sputtered metal layers. Those of skill in the art are aware that the treatments, hard coats, adhesives, and primers described above may also be applied to the additional layer(s), as dictated by the desired construction of the laminate and the process efficiencies.

Solar control properties may be imparted to the additional layer by conventional or non-conventional means. As mentioned above, metal layers reflect infrared light, for example. Any known or non-conventional metal layer that reflects infrared light will be suitable for use in an additional layer. Other materials, such as liquid crystals, particularly cholesteric nematic liquid crystals, also reflect infrared light. See, e.g., U.S. Pat. No. 6,800,337. Suitable infrared absorbing materials include, without limitation, phthalocyanine compounds, naphthalocyanine compounds, rylene compounds, and certain inorganic nanoparticles.

The term “phthalocyanine compound”, as used herein, refers to phthalocyanine and its ions, metallophthalocyanines, phthalocyanine derivatives and their ions, and metallated phthalocyanine derivatives. The term “phthalocyanine derivative”, as used herein, refers to any compound having a phthalocyanine core. Stated alternatively, phthalocyanine derivatives include any molecule comprising a tetrabenzo[b, g, l, q]-5,10,15,20-tetraazaporphyrin moiety and having any number of peripheral substituents in place of any of the peripheral hydrogen atoms bound to the carbon atoms at the 1, 2, 3, 4, 8, 9, 10, 11, 15, 16, 17, 18, 22, 23, 24, or 25 positions of the phthalocyanine moiety. When more than one peripheral substituent is present, they may be the same or different.

Phthalocyanine compounds suitable for use in the invention include any infrared absorbing phthalocyanine compound. The suitable phthalocyanine compounds may function as dyes; that is, they may be soluble in the solar control composition. Alternatively, they may function as pigments; that is, they may be insoluble in the solar control composition.

Suitable phthalocyanine compounds may be metallated, for example with monovalent metals including sodium, potassium, lithium, and the like; with divalent metals including copper, zinc, iron, cobalt, nickel, ruthenium, rhodium, palladium, platinum, manganese, tin, vanadium, calcium and the like; or with trivalent metals, tetravalent metals, or metals of even greater valency.

In general, the charge of any metallated phthalocyanine compound, aside from those containing a divalent metal, will be balanced by a cation or anion of appropriate charge that is often coordinated axially to the metal ion. Examples of suitable ions include, without limitation, halogen anions, metal ions, hydroxide anion, oxide anion (O²⁻), alkoxide anions, and the like. Preferred metallophthalocyanine compounds include, for example, PcAl³⁺Cl⁻, PcAl³⁺Br⁻, PcIn³⁺Cl⁻, PcIn³⁺Br⁻, PcIn³⁺I⁻, PcSi⁴⁺(Cl⁻)₂, PcSi⁴⁺(Br⁻)₂, PcSi⁴⁺(F⁻)₂, PcSn⁴⁺(Cl⁻)₂, PcSn⁴⁺(Br⁻)₂, PcSn⁴⁺(F⁻)₂, PcGe⁴⁺(Cl⁻)₂, PcGe⁴⁺(Br⁻)₂, PcGe⁴⁺(F⁻)₂, PcSi⁴⁺(OH⁻)₂, PcSn⁴⁺(OH⁻)₂, PcGe⁴⁺(OH⁻)₂, PcV⁴⁺O²⁻, and PcTi⁴⁺O²⁻, wherein “Pc” refers to the dianion of phthalocyanine or a peripherally substituted phthalocyanine.

Preferably, however, the phthalocyanine compounds are unmetallated, or, if metallated, the metal comprises copper, nickel, or a mixture of copper and nickel. More preferably, the metal comprises nickel(II), copper(II), or a mixture of nickel(II) and copper(II). Still more preferably, the phthalocyanine compounds are unmetallated.

Phthalocyanine derivatives are preferred. Preferably, one hydrogen atoms of each of the four peripheral benzo rings is substituted, symmetrically or asymmetrically. Also preferably, the phthalocyanine derivative may be substituted at the 1, 4, 8, 11, 15, 18, 22 and 25 positions, or at all sixteen of the peripheral carbon positions.

Suitable substituents for phthalocyanine derivatives include, for example, halogens, alkyl groups, alkoxyalkyl groups, alkoxyl groups, aryloxy groups, partially halogenated or perhalogenated alkyl groups, and the like. The alkyl substituents may be linear or branched.

Specific examples of preferred phthalocyanine compounds include, for example, aluminum 1,4,8,11,15,18,22,25-octabutoxy-29H,31H-phthalocyanine triethylsiloxide; copper(II) 1,4,8,11,15,18,22,25-octabutoxy-29H,31H-phthalocyanine; nickel(II) 1,4,8,11,15,18,22,25-octabutoxy-29H,31H-phthalocyanine; 1,4,8,11,15,18,22,25-octabutoxy-29H,31H-phthalocyanine; zinc 1,4,8,11,15,1 8,22,25-octabutoxy-29H,31H-phthalocyanine; copper(II) 2,3,9,10,16,17,23,24-octakis(octyloxy)-29H,31H-phthalocyanine; 2,3,9,10,16,17,23,24-octakis(octyloxy)-29H,31H-phthalocyanine; silicon 2,3,9,10,16,17,23,24-octakis(octyloxy)-29H,31H-phthalocyanine dihydroxide; zinc 2,3,9,10,16,17,23,24-octakis(octyloxy)-29H,31H-phthalocyanine; and the like and mixtures thereof.

The term “naphthalocyanine compound”, as used herein, refers to naphthalocyanine and its ions, metallonaphthalocyanines, naphthalocyanine derivatives and their ions, and metallated naphthalocyanine derivatives. The term “naphthalocyanine derivative”, as used herein, refers to any compound having a naphthalocyanine core. Stated alternatively, naphthalocyanine derivatives include any molecule comprising a tetranaphthalo[b, g, l, q]-5,10,15,20-tetraazaporphyrin moiety and having any number of peripheral substituents in place of any of the peripheral hydrogen atoms bound to the carbon atoms of the naphthalocyanine moiety. When more than one peripheral substituent is present, they may be the same or different. Napththalocyanine compounds may be metallated or unmetallated. The preferred metal-containing moieties and the preferred substituents are as set forth above for phthalocyanine compounds.

Specific examples of preferred naphthalocyanine compounds include, for example, aluminum 5,9,14,18,23,27,32,36-octabutoxy-2,3-naphthalocyanine triethylsiloxide, copper(II) 5,9,14,18,23,27,32,36-octabutoxy-2,3-naphthalocyanine, nickel(II) 5,9,14,18,23,27,32,36-octabutoxy-2,3-naphthalocyanine, 5,9,14,18,23,27,32,36-octabutoxy-2,3-naphthalocyanine, zinc 5,9,14,18,23,27,32,36-octabutoxy-2,3-naphthalocyanine, and the like and mixtures thereof.

The term “rylene compound”, as used herein, refers to rylenes and their salts and derivatives. The term “rylene derivative”, as used herein, refers to any compound having a rylene core. Stated alternatively, rylene derivatives include any molecule comprising a polycyclic aromatic hydrocarbon (PAH) moiety and having any number of peripheral substituents in place of any of the peripheral hydrogen atoms of the rylene. When more than one peripheral substituent is present, they may be the same or different.

Rylene compounds suitable for use in the invention include any infrared absorbing rylene compound. Suitable rylene compounds are described in U.S. Pat. Nos. 5,405,962; 5,986,099; 6,124,458; 6,486,319; 6,737,159; 6,878,825; and 6,890,377; and U.S. Patent Appln. Publn. Nos. 2004/0049030 and 2004/0068114, for example. The suitable rylene compounds may function as dyes; that is, they may be soluble in the solar control composition. Alternatively, they may function as pigments; that is, they may be insoluble in the solar control composition.

The rylene compound is preferably unsubstituted or, alternatively and still preferably, has up to 16 substituents. Preferred substituents include, for example, halogens, alkyl groups, alkoxyalkyl groups, alkoxide groups, aryloxy groups, arylthio groups, hetaryloxy groups, hetarylthio groups, and the like. Alkyl groups may be branched or unbranched. Substituent groups may be unsubstituted, or any number of the hydrogen atoms of the substituent groups may be substituted with halogens, for example. Specific examples of suitable peripheral substituents usable within the present invention are set forth in the above references.

More preferably, the rylene compound comprises a quaterrylene moiety. Still more preferably, the rylene compound is a peripherally substituted quaterrylene compound. Some rylene compounds suitable for use in the present invention are commercially available from the BASF Corporation of Florham Park, N.J., under the tradenames of Lumogen™ IR 765 and Lumogen™ IR 788.

Alternatively, preferred phthalocyanine, naphthalocyanine, or rylene compounds may be identified empirically, by exhibiting a favorable balance of physical properties.

Suitable inorganic infrared absorbing nanoparticles have a nominal or average particle size of less than about 200 nanometers (nm). Preferably, the nanoparticles have a nominal particle size of less than about 100 nm. More preferably, the nanoparticles have a nominal particle size of less than about 50 nm. Still more preferably, the nanoparticles have a nominal particle size of less than about 30 nm. Still more preferably, the nanoparticles have a nominal particle size within the range of about 1 nm to about 20 nm.

The infrared inorganic absorptive nanoparticles preferably comprise a metal, a metal containing compound, a metal containing composite, or a mixture of two or more substances selected from metals, metal containing compounds, and metal containing composites. Suitable metals include, without limitation, tin, zinc, zirconium, iron, chromium, cobalt, cerium, indium, nickel, silver, copper, platinum, manganese, tantalum, tungsten, vanadium, antimony, molybdenum, lanthanides, and actinides. Suitable metal containing compounds include, without limitation, metal borides, metal oxides, metal nitrides, metal oxynitrides, metal phosphates, and metal sulfides. Suitable metal containing composites include metals doped with at least one doping substance and metal containing compounds doped with at least one doping substance. Suitable doping substances include, without limitation, antimony, antimony compounds, fluorine, fluorine compounds, tin, tin compounds, titanium, titanium compounds, silicon, silicon compounds, aluminum and aluminum compounds.

Metal oxides are preferred infrared absorbing materials, and antimony tin oxide and indium tin oxide are particularly preferred.

Antimony tin oxide can be described as antimony-doped tin oxide, or as tin oxide containing a relatively small amount of antimony oxide. The antimony level is preferably in the range of about 0.1 weight percent to about 20 weight percent based on the total weight of the antimony tin oxide. More preferably, the antimony level is in the range of about 5 weight percent to about 15 weight percent based-on the total weight of the antimony tin oxide. Still more preferred is tin oxide doped to a level in the range of about 8 weight percent to about 10 weight percent with antimony oxide.

Indium tin oxide, in contrast, can be described as tin-doped indium oxide, or as indium oxide containing a relatively small amount of tin oxide. The tin level is preferably in the range of from about 1 to about 15 atomic percent and more preferably from about 2 to about 12 atomic percent based on the sum of tin and indium atoms. Alternatively stated, the molar fraction of the tin content in the ITO powder, (moles Sn)/[(moles Sn)+(moles In)], is preferably from about 0.01 to about 0.15. More preferably, the molar fraction of the tin content is from about 0.02 to about 0.12.

Another preferred class of infrared inorganic absorptive nanoparticles is nanoparticles comprising metal borides. Preferred metal borides include, without limitation, lanthanum hexaboride (LaB₆), praseodymium hexaboride (PrB₆), neodymium hexaboride (NdB₆), cerium hexaboride (CeB₆), gadolinium hexaboride (GdB₆), terbium hexaboride (TbB₆), dysprosium hexaboride (DyB₆), holmium hexaboride (HoB₆), yttrium hexaboride (YB₆), samarium hexaboride (SmB₆), europium hexaboride (EuB₆), erbium hexaboride (ErB₆), thulium hexaboride (TmB₆), ytterbium hexaboride (YbB₆), lutetium hexaboride (LuB₆), strontium hexaboride (SrB₆), calcium hexaboride (CaB₆), titanium boride (TiB₂), zirconium boride (ZrB₂), hafnium boride (HfB₂), vanadium boride (VB₂), tantalum boride (TaB₂), chromium borides (CrB and CrB₂), molybdenum borides (MoB₂, MO₂B₅ and MoB) and tungsten boride (W₂B₅), and the like and mixtures thereof.

More preferably, the nanoparticles comprise antimony tin oxide (ATO), indium tin oxide (ITO), lanthanum hexaboride (LaB₆), or mixtures of two or more of ATO, ITO, or LaB₆. Still more preferably, the nanoparticles consist essentially of ATO, ITO, LaB₆, or mixtures of two or more of ATO, ITO, or LaB₆.

The nanoparticles may be produced through any suitable process, including, for example, vapor phase decomposition methods, plasma vaporizing methods, alkoxide decomposition methods, co-precipitation methods, hydrothermal methods, and the like.

The nanoparticles may be surface treated with, for example, a silane compound, a titanium compound or a zirconium compound, to improve properties such as water resistance, thermal oxidative stability, dispersability, and the like.

An additional layer that is a solar control layer may be a film or sheet that incorporates a solar control material, such as an infrared absorber, for example. Methods of compounding polymeric materials with dyes or pigments and forming the mixtures into films and sheets are well known. The compounded solar control sheets and films may also comprise additives that are described above at levels that may be determined by those of skill in the art. See the “Modern Plastics Encyclopedia,” for example.

Alternatively, a solar control layer may comprise a substrate film or sheet that is coated on one or both surfaces with a solar control composition. The substrate film or sheet preferably comprises one or more of the above mentioned additional layer materials. Preferably, the polymeric substrate is a transparent film. More preferable polymeric substrate film materials include; poly(ethylene terephthalate), polycarbonate, polypropylene, polyethylene, polypropylene, cyclic polyloefins, norbornene polymers, polystyrene, syndiotactic polystyrene, styrene-acrylate copolymers, acrylonitrile-styrene copolymers, poly(ethylene naphthalate), polyethersulfone, polysulfone, nylons, poly(urethanes), acrylics, cellulose acetates, cellulose triacetates, vinyl chloride polymers, polyvinyl fluoride, polyvinylidene fluoride and the like. Still more preferably, the polymeric substrate film is biaxially oriented poly(ethylene terephthalate) film.

The coating on the substrate may result from the application of a coating solution, for example. The term “coating solution” encompasses inorganic absorbing compound(s) dissolved, dispersed or suspended in one or more polymer solutions, one or more polymer precursor solutions, one or more emulsion polymers, or mixtures of one or more polymer solution, polymer precursor solution, or emulsion polymer.

The coating solution may include one or more solvents that dissolve, partially dissolve, disperse, or suspend the binder. The solvent or solvent blends are selected by considering such properties as the solubility of the matrix resin, surface tension of the resulting coating solution and evaporation rate of the coating solution, the polarity and surface characteristics of the infrared absorbing compound(s) to be used and the chemical nature of any dispersants and other additives, the viscosity of the coating, and compatibility of the surface tension of the coating with the surface energy film material. The solvent or solvent blend should also be chemically inert to the binder material(s). The substrate film may be coated by any suitable method.

Likewise, any suitable process may be used to produce the laminates of the present invention. Those of skill in the art are aware that different processes and conditions may be desirable, depending on the composition of the layers in the laminate.

For example, a wedge-shaped polymeric sheet and one or more rigid sheets may be bonded to each other and/or to one or more additional layers in a nip roll process. In such a process, the additional layer(s) are fed along with the film or sheet of the invention through one or more calender roll nips in which the two layers are subjected to moderate pressure and, as a result, form a weakly bonded laminate. Generally, the bonding pressure will be within the range of about 10 psi (0.7 kg/cm²) to about 75 psi (5.3 kg/cm²), and preferably it is within the range of about 25 psi (1.8 kg/cm²) to about 30 psi (2.1 kg/cm²). Typical line speeds are within the range of about 5 feet (1.5 m) to about 30 feet (9.2 m) per minute. Tension within the system may be further maintained through the use of idler rolls.

The nip roll process may be conducted with or without moderate heating, which may be supplied by an oven or by a heated roll, for example. When heated, the polymer surfaces should achieve a temperature sufficient to promote temporary fusion bonding, that is, to cause the surfaces of the polymeric sheet or film to become tacky. Suitable surface temperatures for the preferred polymeric films and sheets of the invention are within the range of about 50° C. to about 120° C., and preferably the surface temperature is about 65° C. After fusion bonding, the laminate may be passed over one or more cooling rolls to ensure that the laminate is sufficiently strong and not tacky when taken up for storage. Process water cooling is generally sufficient to achieve this objective.

This process may further be modified to produce a wide variety of laminate types. For example, the acoustic polymeric sheet of the present invention may be encapsulated between two polymeric films by the addition of a second polymeric film within the above process.

In another typical procedure to make a laminate, an interlayer comprising a wedge-shaped sheet is positioned between two glass plates to form a glass/interlayer/glass pre-press assembly. Preferably, the glass plates have been washed and dried. Air is drawn out from between the layers of the pre-press assembly using a vacuum bag (see, for example, U.S. Pat. No. 3,311,517), a vacuum ring, or another apparatus capable of maintaining a vacuum of approximately 27 to 28 inches (689 to 711 mm Hg). The pre-press assembly is sealed under vacuum, then placed into an autoclave for heating under pressure. With increasing order in the preference given, the temperature in the autoclave is from about 130° C. to about 180° C., from about 120° C. to about 160° C., from about 135° C. to about 160° C., or from about 145° C. to about 155° C. The pressure in the autoclave is preferably about 200 psi (15 bar). With increasing order in the preference given, the pre-press assembly is heated in the autoclave for about 10 to about 50 minutes, about 20 to about 45 minutes, about 20 to about 40 minutes, or about 25 to about 35 minutes. Following the heat and pressure cycle, the air in the autoclave is cooled without adding additional gas to maintain pressure in the autoclave. After about 20 minutes of cooling, the excess air pressure is vented and the laminates are removed from the autoclave.

Alternatively, a nip roll process may be used to produce laminates of the invention. In one such process, the glass/interlayer/glass assembly is heated in an oven at or to between about 80° C. and about 120° C., preferably between about 90° C. and about 100° C., for about 30 minutes. Thereafter, the heated glass/interlayer/glass assembly is passed through a set of nip rolls so that the air in the void spaces between the glass and the interlayer is expelled. The edges of the structure are sealed at this point to produce a pre-press assembly that may be processed under vacuum in an autoclave, as described above, to produce a laminate.

Laminates of the invention may also be produced by non-autoclave processes. Several suitable non-autoclave processes are described in U.S. Pat. Nos. 3,234,062; 3,852,136; 4,341,576; 4,385,951; 4,398,979; 5,536,347; 5,853,516; 6,342,116; 5,415,909; in U.S. Patent Appln. Publn. No. 2004/0182493; in European Patent No. 1 235 683 B1; and in International Patent Appln. Publn. Nos. WO 91/01880 and WO 03/057478 A1, for example. Generally, non-autoclave processes include heating the pre-press assembly and the application of vacuum, pressure or both. For example, the pre-press assembly may be passed through heating ovens and nip rolls.

Abrasion resistant hard coats may be applied to the laminate to protect the outer polymeric layers from scratching, abrasion, and the like. Hard coat compositions are common within the art, but may take the form as disclosed in U.S. Pat. No 4,027,073.

For architectural uses and for uses in transportation such as automobiles, trucks, and trains, a typical laminate of the present invention has two layers of glass and directly self-adhered to the glass in an interlayer of the present invention. The laminate has an overall thickness of about 3 mm to about 30 mm. The interlayer typically has a thickness of about 0.38 mm to about 4.6 mm and each glass layer usually is at least 1 mm thick or thicker. The interlayer of the present invention is adhered directly to the glass and an intermediate adhesive layer or coating between the glass and the interlayer is not required. Similarly, multilayer structured laminates may be formed.

Preferred embodiments of the present invention include laminates comprising at least one rigid sheet and at least one acoustic sheet having a non-uniform thickness profile; laminates comprising at least one rigid sheet, at least one acoustic sheet having a non-uniform thickness profile and at least one polymeric film; laminates comprising at least two rigid sheets and at least one acoustic sheet with a non-uniform thickness profile; and laminates comprising at least two rigid sheets, at least one acoustic wedge shaped sheets with a non-uniform thickness profile, and at least one additional layer in the form of a coating, film or sheet. Also preferably, the acoustic layer in these embodiments may have a maximum thickness or 20 mils or less. Also preferably, the layers having a non-uniform thickness may be non-acoustic layers; in this case, it is preferably that the maximum thickness of the non-uniform layers be 15 mils (0.38 mm) or less. More preferably, the embodiments set forth immediately above are laminates consisting essentially of the specified layers.

In each of the above embodiments, the “second” layer of any film or sheet may be the same as or different from the first layer of that film or sheet. Generally, the layers are adjacent; however, in some preferred embodiments of the invention, the adjacent layers are directly laminated to each other so that they are adjoining or, more preferably, contiguous.

The following examples are provided to describe the invention in further detail. These examples, which set forth a preferred mode presently contemplated for carrying out the invention, are intended to illustrate and not to limit the invention.

### EXAMPLES

Standard Extrusion Conditions.

When polyvinyl butyral sheets are extruded in these Examples, the melt-temperature measured at the slot die is between 190° C. and 215° C. The molten sheet is quenched in a water bath. The self-supporting sheet is passed through a dryer where excess water is allowed to evaporate and then through a relaxer where “quenched in stresses” are substantially relieved. The sheeting is then chilled to less than 10° C., and wound up into rolls.

Standard Lamination Procedure.

A pre-press assembly, in which all the layers in the laminate are cut to the same size and stacked in the desired order, is placed into a vacuum bag and heated at 90 to 100° C. for 30 minutes to remove any air contained between the layers of the pre-press assembly. The pre-press assembly is heated at 135° C. for 30 minutes in an air autoclave at a pressure of 200 psig (14.3 bar). The air is then cooled without adding additional gas, so that the pressure in the autoclave is allowed to decrease. After 20 minutes of cooling, when the air temperature is less than about 50° C., the excess pressure is vented, and the laminate is removed from the autoclave.

Standard Dimensions.

Unless otherwise specified, all layers in a laminate measure 1 meter by 1.12 meters; the Butacite sheet is 15 mils (0.38 mm) thick; and the glass layers are 2.5 mm thick.

### Group I

### Examples 1 Through 19 Pertain to “Acoustic Wedge” Interlayers

### Example 1

A plasticized poly(vinyl butyral) composition is prepared by mixing a poly(vinyl butyral) with a hydroxyl number of 18.5 with the plasticizer tetraethylene glycol diheptanoate and is extruded so that the residence time in the extruder is within 10 to 25 minutes. The feed ratio of the plasticizer to the dry poly(vinyl butyral) flake is 44:100, (wt.:wt.). An aqueous solution of 3:1 potassium acetate:magnesium acetate is injected during the extrusion to deliver a potassium concentration of 50 to 100 ppm. The mixture is extruded under standard conditions. The die lips at extrusion are adjusted to give the sheeting a cross-sectional thickness profile which is wedged. The minimum thickness profile in the roll is 30 mils (762 micrometers) at one sheet edge. The maximum thickness profile in the roll is 38 mils (965 micrometers) at the other edge of the sheet. The roll width is 1.12 meters.

### Example 2

A sheet from Example 1, above, is conditioned at 23% relative humidity (RH) and a temperature of 72° F. overnight. The samples are laid up with a clear annealed float glass plate layer, the conditioned sheet layer, and a clear annealed float glass plate layer. The glass/interlayer/glass pre-press assembly is then laminated according to the standard procedure to produce a glass/interlayer/glass laminate.

### Example 3

A plasticized poly(vinyl butyral) composition is prepared by mixing a poly(vinyl butyral) with a hydroxyl number of 22.1 with the plasticizer tetraethylene glycol diheptanoate. This mixture is extruded so that the residence time in the extruder is within 10 to 25 minutes. The feed ratio of the plasticizer to the dry poly(vinyl butyral) flake is 44:100, (wt.:wt.). An aqueous solution of 3:1 potassium acetate:magnesium acetate is injected during the extrusion to deliver a potassium concentration of 50 to 100 ppm. The mixture is extruded under standard conditions, and then wound up into rolls of more than 366 meters. The die lips at extrusion are adjusted to give the sheeting a cross-sectional thickness profile which is wedged at one end and flat at the other end. The minimum thickness profile in the roll is 32 mils (813 micrometers). The wedge angle is 0.0298°. The wedge covers nominally 70% of the width of the sheet. The average thickness of the flat portion of the sheeting is 38 mils (965 micrometers). The roll width is 1.12 meters.

### Example 4

The sheets from Example 3, above, are conditioned at 23% RH and a temperature of 72° F. overnight. The samples are laid up with a clear annealed float glass plate layer, a sheet from Example 3, above, and a second clear annealed float glass plate layer. The glass/interlayer/glass pre-press assembly is laminated according to the standard procedure, and the glass/interlayer/glass laminate is removed from the autoclave.

### Example 5

The roll from Example 3 is subjected to double sided printing to effect a gradated shade band on the flat portion. The sheet is then rewound into rolls about 366 meters in length using conventional web winding equipment.

### Example 6

The sheets from Example 5 are conditioned at 23% RH and at a temperature of 72° F. overnight. The samples are laid up with a clear annealed float glass plate layer, a conditioned sheet layer from Example 5, and a second clear annealed float glass plate layer. The glass/interlayer/glass pre-press assembly is laminated according to the standard procedure, and the glass/interlayer/glass laminate is removed from the autoclave.

### Example 7

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin™ P, (a product of the Ciba Company), 1.2 grams per liter of Tinuvin™ 123, and 8 grams per liter of octylphenol and is extruded so that the residence time in the extruder is within 10 to 25 minutes. The feed ratio of the plasticizer to the dry poly(vinyl butyral) flake is 44:100, (wt.:wt.). An aqueous solution of 3:1 potassium acetate:magnesium acetate is injected during the extrusion to deliver a potassium concentration of 50 to 100 ppm. The mixture is extruded under standard conditions and then wound up into rolls of more than 366 meters. The die lips at extrusion are adjusted to give the sheeting immediately before slitting a cross-sectional thickness profile which is wedged in the center and flat at both ends. After slitting, two rolls of partially wedged acoustic poly(vinyl butyral) sheet are wound up into rolls to lengths in excess of 366 meters. The minimum thickness profile in each roll is 30 mils (762 micrometers). The wedge angle is 0.0206°. The wedge covers nominally 50% of the width of the sheet. The average thickness of the flat portion of the sheeting is 38 mils (965 micrometers). The roll width is 1.12 meters.

### Example 8

The sheets from Example 7 are conditioned at 23% RH and at a temperature of 72° F. overnight. The samples are laid up with a Solex™ green glass plate, a conditioned sheet from Example 7, and a clear annealed float glass plate layer. The Solex™ layer is 3.0 mm thick. The green glass/interlayer/glass pre-press assembly is laminated according to the standard procedure, and the green glass/interlayer/glass laminate is removed from the autoclave.

### Example 9

The roll from Example 7 is subjected to double sided printing to effect a gradated shade band on the flat portion. The sheet is then rewound into rolls about 366 meters in length using conventional web winding equipment.

### Example 10

The sheets from Example 9 are conditioned at 23% RH and at a temperature of 72° F. overnight. The samples are laid up with a clear annealed float glass plate layer, the conditioned sheet layer from Example 9, and a second clear annealed float glass plate layer. The glass/interlayer/glass pre-press assembly is laminated according to the standard procedure, and the glass/interlayer/glass laminate is removed from the autoclave.

### Example 11

A plasticized poly(vinyl butyral) composition is prepared by mixing a poly(vinyl butyral) with a hydroxyl number of 22.1 with a plasticizer solution of tetraethylene glycol diheptanoate with 4 grams per liter of Tinuvin™ P, 1.2 grams per liter of Tinuvin™ 123, and 8 grams per liter of octylphenol and is extruded so that the residence time in the extruder is within 10 to 25 minutes. The feed ratio of the plasticizer to the dry poly(vinyl butyral) flake is 44:100, (wt.:wt.). An aqueous solution of 3:1 potassium acetate:magnesium acetate is injected during the extrusion to deliver a potassium concentration of 50 to 100 ppm. The mixture is extruded under standard conditions and then wound up into rolls of more than 366 meters. The die lips at extrusion are adjusted to give the sheeting immediately before slitting a cross-sectional thickness profile which is wedged in the center and flat at both ends. After slitting, two rolls of partially wedged acoustic poly(vinyl butyral) sheet are wound up into rolls to lengths in excess of 366 meters. The minimum thickness profile in each roll is 32 mils (0.813 mm). The wedge angle is 0.0298°. The wedge covers nominally 70% of the width of the sheet. The average thickness of the flat portion of the sheeting is 38 mils (0.965 mm). The roll width is 1.12 m.

### Example 12

The sheets from Example 11 are conditioned overnight at 23% RH and 72° F. The samples are laid up with a clear annealed float glass plate layer, the conditioned sheet from Example 11, and a second clear annealed float glass plate layer. The glass/interlayer/glass pre-press assembly is laminated according to the standard procedure, and the glass/interlayer/glass laminate is removed from the autoclave.

### Example 13

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin™ 326, 4 grams per liter of Tinuvin™ 123, and 8 grams per liter of octylphenol and is extruded so that the residence time in the extruder is within 10 to 25 minutes. The feed ratio of the plasticizer to the dry poly(vinyl butyral) flake is 47:100, (wt.:wt.). An aqueous solution of 3:1 potassium acetate:magnesium acetate is injected during the extrusion to deliver a potassium concentration of 35 to 100 ppm. The melt temperature measured at the slot die is between 190° C. and 215° C.

A slot type flat sheet extrusion die with two die lips is used. One or both of the lips is adjustable to alter the width between the opposing lips of the die slot. The transverse sheeting thickness is adjusted and controlled by adjusting the slot width of the die to develop the desired thickness profile at the end of the extrusion line where sheeting is wound into rolls. A finished sheeting thickness target is entered into an automatic transverse direction thickness control system that has programming to adjust the slot width of the flat sheet extrusion die. By establishing the desired finished sheeting thickness target for specific heads-up display sheeting thickness profiles, various thickness profiles are produced to meet individual application requirements and heads-up display system needs.

Using this process, an acoustic poly(vinyl butyral) web is produced. The sheeting is slit along an asymmetric point of the web width and then wound up into rolls. The die lips at extrusion are adjusted to give the sheeting immediately before slitting a cross-sectional thickness profile which is wedged in the center and flat at both ends. After slitting, two rolls of partially wedged acoustic poly(vinyl butyral) sheet are wound up into rolls. The separate rolls are asymmetric about the inner slit position and distinct with respect to overall dimensions and angles. For one of the rolls the total width is 49.5 inches (126 cm), the width of the flat section is 17 inches (43 cm) and the width of the wedge shape section is 32.5 inches (83 cm). The average thickness of total width is 37.9 mils (963 mm), the average thickness of the width of the flat section is 41.2 mils (1046 mm) and the average thickness of the width of the wedge shape section is 36.2 mils (919 mm) with a wedge angle of 0.29 milliradians. For the other roll, the total width is 44.5 inches (113 cm), the width of the flat section is 16 inches (41 cm) and the width of the wedge shape section is 28.5 inches (72 cm). The average thickness of total width is 36.2 mils (919 mm), the average thickness of the width of the flat section is 39.0 mils (991 mm) and the average thickness of the width of the wedge shape section is 35.8 mils (909 mm) with a wedge angle of 0.24 milliradians.

### Example 14

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin™ P, 1.2 grams per liter of Tinuvin™ 123, and 8 grams per liter of octylphenol and is extruded so that the residence time in the extruder is within 10 to 25 minutes. The feed ratio of the plasticizer to the dry poly(vinyl butyral) flake is 49:100, (wt.:wt.). An aqueous solution of 3:1 potassium acetate:magnesium acetate is injected during the extrusion to deliver a potassium concentration of 50 to 100 ppm. The mixture is extruded under standard conditions and then wound up into rolls of more than 366 meters. The die lips at extrusion are adjusted to give the sheeting immediately before slitting a cross-sectional thickness profile which is flat in the center and wedged at both ends. After slitting, two rolls of partially wedged acoustic poly(vinyl butyral) sheet are wound up into rolls to lengths in excess of 366 meters. The minimum thickness profile in each roll is 30 mils (0.762 mm). The wedge angle is 0.0206°. The wedge covers nominally 50% of the width of the sheet. The average thickness of the flat portion of the sheeting is 38 mils (0.965 mm). The roll width is 1.12 m.

### Example 15

The sheets from Example 14 are conditioned overnight at 23% RH and 72° F. The samples are laid up with a clear annealed float glass plate layer, the conditioned sheet from Example 14, and a second clear annealed float glass plate layer. The glass/interlayer/glass pre-press assembly is laminated according to the standard procedure, and the glass/interlayer/glass laminate is removed from the autoclave.

### Example 16

The sheets from Example 1 and an Evasafe™ ethylene vinyl acetate sheet (available from the Bridgestone Company of Tokyo, Japan), are conditioned overnight at 23% RH and 72° F. The samples are laid up with a clear annealed float glass plate layer, the conditioned Evasafe™ sheet, the conditioned sheet from Example 1, and a second clear annealed float glass plate layer. The Evasafe™ layer is 15 mils (0.38 mm) thick. The glass/interlayer/glass pre-press assembly is laminated according to the standard procedure, and the glass/interlayer/glass laminate is removed from the autoclave.

### Example 17

A sheet from Example 3 and a Butacite® poly(vinyl butyral) sheet are conditioned overnight at 23% RH and 72° F. The samples are laid up with a clear annealed float glass plate layer the conditioned Butacite® sheet, the conditioned sheet layer from Example 3, and a second clear annealed float glass plate layer. The glass/interlayer/glass pre-press assembly is laminated according to the standard procedure, and-the glass/interlayer/glass laminate is removed from the autoclave.

### Example 18

A sheet from Example 7 and two Butacite® poly(vinyl butyral) sheets are conditioned overnight at 23% RH and 72° F. The samples are laid up with a clear annealed float glass plate layer, the conditioned Butacite® sheet, the conditioned sheet from Example 7, a second Butacite® poly(vinyl butyral) sheet, and a second clear annealed float glass plate layer. The glass/interlayer/glass pre-press assembly is laminated according to the standard procedure, and the glass/interlayer/glass laminate is removed from the autoclave.

### Preparative Example PE1

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin™ P, 1.2 grams per liter of Tinuvin™ 123, and 8 grams per liter of octylphenol and is extruded so that the residence time in the extruder is within 10 to 25 minutes. The feed ratio of the plasticizer to the dry poly(vinyl butyral) flake is 36:100, (wt.:wt.). An aqueous solution of 3:1 potassium acetate:magnesium acetate is injected during the extrusion to deliver a potassium concentration of 50 to 100 ppm. The mixture is extruded under standard conditions and wound up into rolls of more than 366 meters. The die lips at extrusion are adjusted to give the sheeting immediately before slitting a cross-sectional thickness profile which is flat in the center and wedged at both ends. After slitting, two rolls of partially wedged poly(vinyl butyral) sheet are wound up into rolls to lengths in excess of 366 meters. The minimum thickness profile in each roll is 30 mils (762 micrometers). The wedge angle is 0.0206°. The wedge covers nominally 50% of the width of the sheet. The average thickness of the flat portion of the sheeting is 38 mils (965 micrometers). The roll width is 1.12 meters.

### Preparative Example PE2

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin™ P, 1.2 grams per liter of Tinuvin™ 123, and 8 grams per liter of octylphenol and is extruded so that the residence time in the extruder is within 10 to 25 minutes. The feed ratio of the plasticizer to the dry poly(vinyl butyral) flake is 49:100, (wt.:wt.). An aqueous solution of 3:1 potassium acetate:magnesium acetate is injected during the extrusion to deliver a potassium concentration of 50 to 100 ppm. The mixture is extruded under standard conditions. The die lips at extrusion are adjusted to give the sheeting immediately before slitting a flat cross-sectional thickness profile. After slitting, two rolls of flat acoustic poly(vinyl butyral) sheet are wound up into rolls. The average thickness profile in each roll is 30 mils (762 micrometers). The roll width is 1.12 meters.

### Example 19

A sheet from Preparative Example PE1 and a sheet from Preparative Example PE2 are conditioned overnight at 23% RH and 72° F. The samples are laid up with a clear annealed float glass plate layer, the conditioned sheet from Preparative Example PE1, the conditioned sheet from Preparative Example PE2, and a second clear annealed float glass plate layer. The glass/interlayer/glass pre-press assembly is laminated according to the standard procedure, and the glass/interlayer/glass laminate is removed from the autoclave.

### Group II

### Examples 1A Through 36B Pertain to “Thin Wedge” and “Thin Acoustic Wedge” Interlayers

### Example 1A

A plasticized poly(vinyl butyral) composition is prepared by mixing a poly(vinyl butyral) with a hydroxyl number of 18.5 with the plasticizer tetraethylene glycol diheptanoate and is extruded so that the residence time in the extruder is within 10 to 25 minutes. The feed ratio of the plasticizer to the dry poly(vinyl butyral) flake is 44:100, (wt.:wt.). An aqueous solution of 3:1 potassium acetate:magnesium acetate is injected during the extrusion to deliver a potassium concentration of 50 to 100 ppm. The mixture is extruded under standard conditions. The die lips at extrusion are adjusted to give the sheeting a cross-sectional thickness profile which is wedged. The minimum thickness profile in the roll is 7 mils, (0.18 mm) at one sheet edge. The maximum thickness profile in the roll is 15 mils, (0.38 mm) at the other edge of the sheet. The roll width is 1.12 meters.

### Example 1B

The procedure of Example 1A is carried out under the same conditions, on the same materials and in the same amounts, except that the feed ratio of the plasticizer to the dry poly(vinyl butyral) flake is 36:100, to produce an acoustic PVB web.

### Example 2A

A sheet from Example 1A, above, and a Butacite® poly(vinyl butyral) sheet having a uniform thickness are conditioned overnight at 23% RH and 72° F. The samples are laid up with a clear annealed float glass plate layer, the conditioned sheet from Example 1A, the conditioned Butacite® sheet, and a second clear annealed float glass plate layer. The glass/interlayer/glass pre-press assembly is laminated according to the standard procedure, and the glass/interlayer/glass laminate is removed from the autoclave.

### Preparative Example PE 1A

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin™ P, 1.2 grams per liter of Tinuvin™ 123, and 8 grams per liter of octylphenol and is extruded so that the residence time in the extruder is within 10 to 25 minutes. The feed ratio of the plasticizer to the dry poly(vinyl butyral) flake is 46:100, (wt.:wt.). An aqueous solution of 3:1 potassium acetate:magnesium acetate is injected during the extrusion to deliver a potassium concentration of 50 to 100 ppm. The mixture is extruded under standard conditions. The die lips at extrusion are adjusted to give the sheeting immediately before slitting a flat cross-sectional thickness profile. After slitting, two rolls of flat acoustic poly(vinyl butyral) sheet are wound up into rolls. The average thickness profile in each roll is 20 mils (0.51 mm). The roll width is 1.12 meters.

### Example 3A

A sheet from Example 1A and a sheet from Preparative Example PE 1A are conditioned at 23% RH and 72° F. overnight. The samples are laid up with a clear annealed float glass plate layer, the conditioned sheet from Example 1A, the conditioned sheet from Preparative Example PE 1A, and a second clear annealed float glass plate layer. The glass/interlayer/glass pre-press assembly is laminated according to the standard procedure, and the glass/interlayer/glass laminate is removed from the autoclave.

### Example 4A

A sheet from Example 1A, a surface flame-treated, biaxially oriented PET film, and a Butacite® poly(vinyl butyral) sheet are conditioned overnight at 23% RH and 72° F. The samples are laid up with a clear annealed float glass plate layer, the conditioned sheet from Example 1A, the conditioned surface flame-treated PET film, the conditioned Butacite® sheet and a second clear annealed float glass plate layer. The PET film is 4 mils (0.10 mm) thick. The glass/interlayer/glass pre-press assembly is laminated according to the standard procedure, and the glass/interlayer/glass laminate is removed from the autoclave.

### Example 5A

A sheet from Example 1A, an XIR™-70 HP Auto film (available from Southwall Technologies, Inc., of Palo Alto, Calif.), and a sheet from Preparative Example PE 1A are conditioned at 23% RH and at a temperature of 72° F. overnight. The samples are laid up with a clear annealed float glass plate layer, the conditioned sheet from Example 1A, the conditioned XIR™-70 HP Auto film, the conditioned sheet from Preparative Example PE 1A, and a second clear annealed float glass plate layer. All layers measure 1 m by 1.12 m. The XIR™-70 HP Auto film is 2 mils (0.05 mm) thick. The glass/interlayer/glass assembly is laminated according to the standard procedure, and the glass/interlayer/glass laminate is removed from the autoclave.

### Examples 2B Through 5B

The procedures of Examples 2A through 5A are carried out under the same conditions, on the same materials and in the same amounts, except that the sheet of Example 1B is substituted for the sheet of Example 1A.

### Example 6A

A plasticized poly(vinyl butyral) composition is prepared by mixing a poly(vinyl butyral) with a hydroxyl number of 22.1 with the plasticizer tetraethylene glycol diheptanoate and is extruded so that the residence time in the extruder is within 10 to 25 minutes. The feed ratio of the plasticizer to the dry poly(vinyl butyral) flake is 44:100, (wt.:wt.). An aqueous solution of 3:1 potassium acetate:magnesium acetate is injected during the extrusion to deliver a potassium concentration of 50 to 100 ppm. The mixture is extruded under standard conditions and then wound up into rolls of more than 366 meters. The die lips at extrusion are adjusted to give the sheeting a cross-sectional thickness profile which is wedged at one end and flat at the other end. The minimum thickness profile in the roll is 9 mils (0.23 mm). The wedge angle is 0.0298°. The wedge covers nominally 70% of the width of the sheet. The average thickness of the flat portion of the sheeting is 15 mils (38 mm). The roll width is 1.12 meters.

### Example 6B

The procedure of Example 6A is carried out under the same conditions, on the same materials and in the same amounts, except that the plasticizer is triethylene glycol di-2-ethylhexanoate and the feed ratio of the plasticizer to the dry poly(vinyl butyral) flake is 36:100, to produce an acoustic PVB web.

### Example 7A

Two sheets from Example 6A are conditioned overnight at 23% RH and 72° F. The samples are laid up with a clear annealed float glass plate layer, the two conditioned sheets from Example 6A, and a second clear annealed float glass plate layer. The glass/interlayer/glass pre-press assembly is laminated according to the standard procedure, and the glass/interlayer/glass laminate is removed from the autoclave.

### Preparative Example PE 2A

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin™ P, 1.2 grams per liter of Tinuvin™ 123, and 8 grams per liter of octylphenol and is extruded so that the residence time in the extruder is within 10 to 25 minutes. The feed ratio of the plasticizer to the dry poly(vinyl butyral) flake is 49:100, (wt.:wt.). An aqueous solution of 3:1 potassium acetate:magnesium acetate is injected during the extrusion to deliver a potassium concentration of 50 to 100 ppm. The mixture is extruded under standard conditions, then slit along the mid-point of the web width and wound up into rolls. The die lips at extrusion are adjusted to give the sheeting immediately before slitting a flat cross-sectional thickness profile. After slitting, two rolls of flat acoustic poly(vinyl butyral) sheet are wound up into rolls. The average thickness profile in each roll is 15 mils (0.38 mm). The roll width is 1.12 meters.

### Example 8A

A sheet from Example 6A and a sheet from Preparative Example PE 2A are conditioned overnight at 23% RH and 72° F. The samples are laid up with a clear annealed float glass plate layer, the conditioned sheet from Example 6A, the conditioned sheet from Preparative Example PE 2A, and a second clear annealed float glass plate layer. The glass/interlayer/glass pre-press assembly is laminated according to the standard procedure, and the glass/interlayer/glass laminate is removed from the autoclave.

### Example 9A

A sheet from Example 6A, a poly(allyl amine)-primed, biaxially oriented PET film, and a Butacite® poly(vinyl butyral) sheet are conditioned overnight at 23% RH and 72° F. The samples are laid up with a clear annealed float glass plate layer, the conditioned sheet from Example 6A, the conditioned poly(allyl amine)-primed PET film, the conditioned Butacite® sheet, and a second clear annealed float glass plate layer. The PET film is 4 mils (0.10 mm) thick. The glass/interlayer/glass pre-press assembly is laminated according to the standard procedure, and the glass/interlayer/glass laminate is removed from the autoclave.

### Example 10A

Two sheets from Example 6A and an XIR™-75 Auto Blue V-1 film (available from Southwall Technologies) are conditioned overnight at 23% RH and 72° F. The samples are laid up with a clear annealed float glass plate layer, the first conditioned sheet from Example 6A, the conditioned XIR™-75 Auto Blue V-1 film, the second conditioned sheet from Example 6A, and a second clear annealed float glass plate layer. The Auto Blue film is 1.8 mils (0.046 mm) thick. The glass/interlayer/glass pre-press assembly is laminated according to the standard procedure, and the glass/interlayer/glass laminate is removed from the autoclave.

### Example 11A

The roll from Example 6A is subjected to double sided printing to effect a gradated shade band on the flat portion. The sheet is then rewound into rolls about 366 meters in length using conventional web winding equipment.

### Example 12A

A sheet from Example 11A and a Butacite® poly(vinyl butyral) sheets are conditioned overnight at 23% RH and 72° F. The samples are laid up with a clear annealed float glass plate layer, the conditioned sheet from Example 11A, the conditioned Butacite® sheet, and a second clear annealed float glass plate layer. The glass/interlayer/glass pre-press assembly is laminated according to the standard procedure, and the glass/interlayer/glass laminate is removed from the autoclave.

### Example 13A

A sheet from Example 11A, a Soft Look™ UV/IR 25 film (available from the Tomoegawa Paper Company, Ltd., of Tokyo, Japan), and a sheet from Preparative Example PE 1A are conditioned overnight at 23% RH and 72° F. The samples are laid up with a clear annealed float glass plate layer, the conditioned sheet from Example 11A, the conditioned Soft Look™ UV/IR 25 film, the conditioned sheet from Preparative Example PE 1A, and a second clear annealed float glass plate layer. The glass/interlayer/glass pre-press assembly is laminated according to the standard procedure, and the glass/interlayer/glass laminate is removed from the autoclave.

### Examples 7B Through 13B

The procedures of Examples 7A through 13A are carried out under the same conditions, on the same materials and in the same amounts, except that the sheet of Example 6B is substituted for the sheet of Example 6A.

### Example 14A

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin™ P, 1.2 grams per liter of Tinuvin™ 123, and 8 grams per liter of octylphenol and is extruded so that the residence time in the extruder is within 10 to 25 minutes. The feed ratio of the plasticizer to the dry poly(vinyl butyral) flake is 44:100, (wt.:wt.). An aqueous solution of 3:1 potassium acetate:magnesium acetate is injected during the extrusion to deliver a potassium concentration of 50 to 100 ppm. The mixture is extruded under standard conditions, then slit along the mid-point of the web width and wound up into rolls of more than 366 meters. The die lips at extrusion are adjusted to give the sheeting immediately before slitting a cross-sectional thickness profile which is wedged in the center and flat at both ends. After slitting, two rolls of partially wedged poly(vinyl butyral) sheet are wound up into rolls to lengths in excess of 366 meters. The minimum thickness profile in each roll is 7 mils (0.18 mm). The wedge angle is 0.0206°. The wedge covers nominally 50% of the width of the sheet. The average thickness of the flat portion of the sheeting is 15 mils (0.38 mm). The roll width is 1.12 meters.

### Example 14B

The procedure of Example 14A is carried out under the same conditions, on the same materials and in the same amounts, except that the plasticizer is triethylene glycol di-2-ethylhexanoate and the feed ratio of the plasticizer to the dry poly(vinyl butyral) flake is 33:100, to produce an acoustic PVB web.

### Example 15A

A sheet from Example 14A and a Butacite® poly(vinyl butyral) sheet are conditioned overnight at 23% RH and 72° F. The samples are laid up with a clear annealed float glass plate layer, the conditioned sheet from Example 14A, the conditioned Butacite® sheet, and a second clear annealed float glass plate layer. The glass/interlayer/glass pre-press assembly is laminated according to the standard procedure, and the glass/interlayer/glass laminate is removed from the autoclave.

### Example 16A

A sheet from Example 14A and a sheet from Preparative Example PE 2A are conditioned overnight at 23% RH and 72° F. The samples are laid up with a clear annealed float glass plate layer, the conditioned sheet from Example 14A, the conditioned sheet from Preparative Example PE 2A, and a second clear annealed float glass plate layer. The glass/interlayer/glass pre-press assembly is laminated according to the standard procedure, and the glass/interlayer/glass laminate is removed from the autoclave.

### Example 17A

A sheet from Example 14A, a surface flame-treated, biaxially oriented PET film, and an Evasafe™ ethylene vinyl acetate sheet are conditioned overnight at 23% RH and 72° F. The samples are laid up with a clear annealed float glass plate layer, the conditioned sheet from Example 14A, the conditioned surface flame-treated PET film, the conditioned Evasafe™ sheet, and a second clear annealed float glass plate layer. The Evasafe™ sheet is 15 mils (0.38 mm) thick and the PET film is 4 mils (0.10 mm) thick. The glass/interlayer/glass pre-press assembly is laminated according to the standard procedure, and the glass/interlayer/glass laminate is removed from the autoclave.

### Example 18A

A sheet from Example 14A, an XIR™-75 Green film (available from Southwall Technologies), and a sheet from Preparative Example PE 1A are conditioned overnight at 23% RH and 72° F. The samples are laid up with a clear annealed float glass plate layer, the conditioned sheet from Example 14A, the conditioned XIR™-75 Green film, the conditioned sheet from Preparative Example PE 1A, and a second clear annealed float glass plate layer. The glass/interlayer/glass pre-press assembly is laminated according to the standard procedure and the glass/interlayer/glass laminate is removed from the autoclave.

### Example 19A

The roll from Example 14A, above, is subjected to double sided printing to effect a gradated shade band on the flat portion. The sheet is then rewound into rolls about 366 meters in length using conventional web winding equipment.

### Example 20A

A sheet from Example 19A and a sheet from Preparative Example PE 2A are conditioned overnight at 23% RH and 72° F. The samples are laid up with a clear annealed float glass plate layer, the conditioned sheet from Example 19A, the conditioned sheet from Preparative Example PE 2A, and a second clear annealed float glass plate layer. The glass/interlayer/glass pre-press assembly is laminated according to the standard procedure and the glass/interlayer/glass laminate is removed from the autoclave.

### Example 21A

A sheet from Example 19A, a RAYBARRIER™ TFK-2583 solar control film (available from the Sumitomo Osaka Cement Company), and a Butacite® poly(vinyl butyral) sheet are conditioned overnight at 23% RH and 72° F. The samples are laid up with a clear annealed float glass plate layer, the conditioned sheet from Example 19A, the conditioned RAYBARRIER™ TFK-2583 film, the conditioned Butacite® sheet and a second clear annealed float glass plate layer. The glass/interlayer/glass pre-press assembly is laminated according to the standard procedure and the glass/interlayer/glass laminate is removed from the autoclave.

### Examples 15B Through 21B

The procedures of Examples 15A through 21A are carried out under the same conditions, on the same materials and in the same amounts, except that the sheet of Example 14B is substituted for the sheet of Example 14A.

### Example 22A

A plasticized poly(vinyl butyral) composition is prepared by mixing a poly(vinyl butyral) with a hydroxyl number of 22.1 with a plasticizer solution of tetraethylene glycol diheptanoate with 4 grams per liter of Tinuvin® P, (a product of the Ciba Company), 1.2 grams per liter of Tinuvin® 123, (a product of the Ciba Company), and 8 grams per liter of octylphenol and is extruded so that the residence time in the extruder is within 10 to 25 minutes. The feed ratio of the plasticizer to the dry poly(vinyl butyral) flake is 44:100, (wt.:wt.). An aqueous solution of 3:1 potassium acetate:magnesium acetate is injected during the extrusion to deliver a potassium concentration of 50 to 100 ppm. The mixture is extruded under standard conditions, then slit along the mid-point of the web width and wound up into rolls of more than 366 meters. The die lips at extrusion are adjusted to give the sheeting immediately before slitting a cross-sectional thickness profile which is wedged in the center and flat at both ends. After slitting, two rolls of partially wedged poly(vinyl butyral) sheet are wound up into rolls to lengths in excess of 366 meters. The minimum thickness profile in each roll is 9 mils (0.23 mm). The wedge angle is 0.0298°. The wedge covers nominally 70% of the width of the sheet. The average thickness of the flat portion of the sheeting is 15 mils (0.38 mm). The roll width is 1.12 meters.

### Example 22B

The procedure of Example 23A is carried out under the same conditions, on the same materials and in the same amounts, except that the feed ratio of the plasticizer to the dry poly(vinyl butyral) flake is 33:100, to produce an acoustic PVB web.

### Example 23A

A sheet from Example 22A and a Butacite® sheet are conditioned overnight at 23% RH and 72° F. The samples are laid up with a clear annealed float glass plate layer, the conditioned sheet from Example 22A, the conditioned Butacite® sheet, and a second clear annealed float glass plate layer. The glass/interlayer/glass pre-press assembly is laminated according to the standard procedure, and the glass/interlayer/glass laminate is removed from the autoclave.

### Example 24A

A sheet from Example 22A and a sheet from Preparative Example PE 1A are conditioned overnight at 23% RH and 72° F. The samples are laid up with a clear annealed float glass plate layer, the conditioned sheet from Example 22A, the conditioned sheet from Preparative Example PE 1A, and a clear annealed float glass plate layer. The glass/interlayer/glass pre-press assembly is laminated according to the standard procedure, and the glass/interlayer/glass laminate is removed from the autoclave.

### Example 25A

A sheet from Example 22A, a surface flame-treated, biaxially oriented PET film, (1 meter by 1.12 meters by 4 mils (0.10 mm) thick), and a Butacite® poly(vinyl butyral) sheets are conditioned overnight at 23% RH and 72° F. The samples are laid up with a Solex™ green glass plate layer, the conditioned sheet from Example 22A, the conditioned surface flame-treated PET film, the conditioned Butacite® sheet and a second clear annealed float glass plate layer. The PET film is 4 mils (0.10 mm) thick. The green glass/interlayer/glass pre-press assembly is laminated according to the standard procedure and the green glass/interlayer/glass laminate is removed from the autoclave.

### Example 26A

A sheets from Example 22A, an XIR™-70 HP film, and a sheet from Preparative Example PE 2A are conditioned overnight at 23% RH and 72° F. The samples are laid up with a clear annealed float glass plate layer, the conditioned sheet from Example 22A, the conditioned XIR®-70 HP film, the conditioned sheet from Preparative Example PE 2A, and a second clear annealed float glass plate layer. The glass/interlayer/glass pre-press assembly is laminated according to the standard procedure, and the glass/interlayer/glass laminate is removed from the autoclave.

### Examples 23B Through 26B

The procedures of Examples 23A through 26A are carried out under the same conditions, on the same materials and in the same amounts, except that the sheet of Example 22B is substituted for the sheet of Example 22A.

### Example 27A

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin™ P, 1.2 grams per liter of Tinuvin™ 123, and 8 grams per liter of octylphenol and is extruded so that the residence time in the extruder is within 10 to 25 minutes. The feed ratio of the plasticizer to the dry poly(vinyl butyral) flake is 47:100, (wt.:wt.). An aqueous solution of 3:1 potassium acetate:magnesium acetate is injected during the extrusion to deliver a potassium concentration of 35 to 100 ppm. The melt temperature measured at the slot die is between 190° C. and 215° C. A slot type flat sheet extrusion die with two die lips is used. One or both of the lips is adjustable to alter the width between the opposing lips of the die slot.

The transverse sheeting thickness is adjusted and controlled by adjusting the slot width of the die to develop the desired thickness profile at the end of the extrusion line where sheeting is wound into rolls. A finished sheeting thickness target is entered into an automatic transverse direction thickness control system that has programming to adjust the slot width of the flat sheet extrusion die. By establishing the desired finished sheeting thickness target for specific heads-up display sheeting thickness profiles, various thickness profiles are produced to meet individual application requirements and heads-up display system needs.

Using this process, a poly(vinyl butyral) web is produced. The sheeting is slit along an asymmetric point of the web width and then wound up into rolls. The die lips at extrusion are adjusted to give the sheeting immediately before slitting a cross-sectional thickness profile which is wedged in the center and flat at both ends. After slitting, two rolls of partially wedged poly(vinyl butyral) sheet are wound up into rolls. The separate rolls are asymmetric about the inner slit position and distinct with respect to overall dimensions and angles. For one of the rolls the total width is 49.5 inches (126 cm), the width of the flat section is 17 inches (43 cm) and the width of the wedge shape section is 32.5 inches (83 cm). The average thickness of total width is 11.7 mils (0.30 mm), the average thickness of the width of the flat section is 15 mils (0.38 mm) and the average thickness of the width of the wedge shape section is 10 mils (0.25 mm) with a wedge angle of 0.29 milliradians. For the other of the roll the total width is 44.5 inches (113 cm), the width of the flat section is 16 inches (41 cm) and the width of the wedge shape section is 28.5 inches (72 cm). The average thickness of total width is 12.2 mils (0.32 mm), the average thickness of the width of the flat section is 15 mils (0.38 mm) and the average thickness of the width of the wedge shape section is 11.8 mils (0.30 mm) with a wedge angle of 0.24 milliradians.

### Example 27B

The procedure of Example 27A is carried out under the same conditions, on the same materials and in the same amounts, except that the plasticizer is triethylene glycol di-2-ethylhexanoate and the feed ratio of the plasticizer to the dry poly(vinyl butyral) flake is 34:100, to produce an acoustic PVB web.

### Example 28A.

A sheet from Example 27A and a Butacite® poly(vinyl butyral) sheet are conditioned overnight at 23% RH and 72° F. The samples are laid up with a clear annealed float glass plate layer, the conditioned sheet from Example 27A, the conditioned Butacite® sheet and a second clear annealed float glass plate layer. The glass/interlayer/glass pre-press assembly is laminated according to the standard procedure, and the glass/interlayer/glass laminate is removed from the autoclave.

### Example 29A

A sheet from Example 27A and a sheet from Preparative Example PE 2A are conditioned overnight at 23% RH and 72° F. The samples are laid up with a clear annealed float glass plate layer, the conditioned sheet from Example 27A, the conditioned sheet from Preparative Example PE 2A, and a second clear annealed float glass plate layer. The glass/interlayer/glass pre-press assembly is laminated according to the standard procedure, and the glass/interlayer/glass laminate is removed from the autoclave.

### Example 30A

A sheet from Example 27A, a Soft Look™ UV/IR 50 film, and a Butacite® poly(vinyl butyral) sheet are conditioned overnight at 23% RH and 72° F. The samples are laid up with a clear annealed float glass plate layer, the conditioned sheet from Example 27A, the conditioned Soft Look™ UV/IR 50 film, the conditioned Butacite® sheet, and a second clear annealed float glass plate layer. The glass/interlayer/glass pre-press assembly is laminated according to the standard procedure, and the glass/interlayer/glass laminate is removed from the autoclave.

### Example 31A.

A sheet from Example 27A, an XIR™-70 HP Auto film, and a sheet from Preparative Example PE 1A are conditioned overnight at 23% RH and 72° F. The samples are laid up with a clear annealed float glass plate layer, the conditioned sheet from Example 27A, the conditioned XIR™-70 HP Auto film, the conditioned sheet from Preparative Example PE 1A, and a second clear annealed float glass plate layer. The glass/interlayer/glass pre-press assembly is laminated according to the standard procedure, and the glass/interlayer/glass laminate is removed from the autoclave.

### Examples 28B Through 31B

The procedures of Examples 28A through 31A are carried out under the same conditions, on the same materials and in the same amounts, except that the sheet of Example 27B is substituted for the sheet of Example 27A.

### Example 32A

A plasticized poly(vinyl butyral) composition is prepared by mixing a poly(vinyl butyral) with a hydroxyl number of 18.5 with a plasticizer solution of tetraethylene glycol diheptanoate with 4 grams per liter of Tinuvin™ P, 1.2 grams per liter of Tinuvin™ 123, and 8 grams per liter of octylphenol and is extruded so that the residence time in the extruder is within 10 to 25 minutes. The feed ratio of the plasticizer to the dry poly(vinyl butyral) flake is 49:100, (wt.:wt.). An aqueous solution of 3:1 potassium acetate:magnesium acetate is injected during the extrusion to deliver a potassium concentration of 50 to 100 ppm. The mixture is extruded under standard conditions, then slit along the mid-point of the web width and wound up into rolls of more than 366 meters. The die lips at extrusion are adjusted to give the sheeting immediately before slitting a cross-sectional thickness profile which is flat in the center and wedged at both ends. After slitting, two rolls of partially wedged poly(vinyl butyral) sheet are wound up into rolls to lengths in excess of 366 meters. The minimum thickness profile in each roll is 7 mils (0.18 mm). The wedge angle is 0.0206°. The wedge covers nominally 50% of the width of the sheet. The average thickness of the flat portion of the sheeting is 15 mils (0.38 mm). The roll width is 1.12 meters.

### Example 32B

The procedure of Example 32A is carried out under the same conditions, on the same materials and in the same amounts, except that the plasticizer is triethylene glycol di-2-ethylhexanoate and the feed ratio of the plasticizer to the dry poly(vinyl butyral) flake is 35:100, to produce an acoustic PVB web.

### Example 33A

A sheet from Example 32A and a Butacite® poly(vinyl butyral) sheet are conditioned overnight at 23% RH and 72° F. The samples are laid up with a clear annealed float glass plate layer, the conditioned sheet from Example 32A, the conditioned Butacite® sheet and a second clear annealed float glass plate layer. The glass/interlayer/glass pre-press assembly is laminated according to the standard procedure, and the glass/interlayer/glass laminate is removed from the autoclave.

### Example 34A

A sheet from Example 32A and a sheet from Preparative Example PE 1A are conditioned overnight at 23% RH and 72° F. The samples are laid up with a clear annealed float glass plate layer, the conditioned sheet from Example 32A, the conditioned sheet from Preparative Example PE 1A, and a second clear annealed float glass plate layer. The glass/interlayer/glass pre-press assembly is laminated according to the standard procedure, and the glass/interlayer/glass laminate is removed from the autoclave.

### Example 35A

A sheet from Example 32A, above a RAYBARRIER® TFM-5065 film, and a sheet from Preparative Example PE 1A are conditioned overnight at 23% RH and 72° F. The samples are laid up with a clear annealed float glass plate layer, the conditioned sheet from Example 32A, the conditioned RAYBARRIER® TFM-5065 film, the conditioned sheet from Preparative Example PE 1A, and a clear annealed float glass plate layer. The glass/interlayer/glass pre-press assembly is laminated according to the standard procedure, and the glass/interlayer/glass laminate is removed from the autoclave.

### Example 36A

A sheet from Example 32A, an XIR™-75 Auto Blue V-1 film, and a sheet from Preparative Example PE 2A are conditioned overnight at 23% RH and 72° F. The samples are laid up with a clear annealed float glass plate layer, the conditioned sheet from Example 32A, the conditioned XIR™-75 Auto Blue V-1 film, the conditioned sheet from Preparative Example PE 2A, and a second clear annealed float glass plate layer. The glass/interlayer/glass pre-press assembly is laminated according to the standard procedure, and the glass/interlayer/glass laminate is removed from the autoclave.

### Examples 33B Through 36B

The procedures of Examples 33A through 36A are carried out under the same conditions, on the same materials and in the same amounts, except that the sheet of Example 32B is substituted for the sheet of Example 32A.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. An interlayer for use in a heads-up display, said interlayer having a non-uniform thickness profile and said interlayer comprising one or more adjoining layers; wherein a first layer of the one or more adjoining layers has a non-uniform thickness profile; and wherein the first layer is optionally an acoustic layer, provided that when the first layer is not an acoustic layer, the maximum thickness of the interlayer is 15 mils (0.38 mm) or less.

2. The interlayer of claim 1, wherein the first layer is an acoustic layer comprising polyvinyl butyral.

3. The interlayer of claim 1, wherein the first layer is a non-acoustic layer comprising polyvinyl butyral, and further comprising a second layer of the one or more adjoining layers, said second layer being an acoustic layer comprising polyvinyl butyral.

4. The interlayer of claim 1, wherein the first layer is a non-acoustic layer comprising polyvinyl butyral; and further comprising a second layer of the one or more adjoining layers, said second layer being an acoustic layer based on a polymer other than polyvinyl butyral; and further comprising a third layer of the one or more adjoining layers, said third layer comprising polyvinyl butyral.

5. The interlayer of claim 1, wherein the interlayer comprises at least one area of a uniform thickness profile and at least one area of a non-uniform thickness profile.

6. The interlayer of claim 1, wherein the interlayer comprises at least two areas of a uniform thickness profile and at least two areas of a non-uniform thickness profile.

7. The interlayer of claim 1 having the non-uniform thickness profile depicted in any of FIGS. 1 through 8.

8. The interlayer of claim 1 having a thickness of 20 mils or less.

9. A laminate for a heads-up display comprising the interlayer of claim 1.

10. The laminate of claim 9, further comprising one or more additional layers, wherein the one or more additional layers comprise at least one transparent rigid sheet.
